(19) United States
(12) Patent Application Publication
(10) Pub. No.: US 2006/0280421 A1
(43) Pub. Date: Dec. 14, 2006

(54) Variable light attenuator

(75) Inventors: Hirokazu Tanaka, Kyoto (JP); Yoichi Nakanishi, Kyoto (JP); Ryuji Kawamoto, Kyoto (JP); Yuichi Suzuki, Kyoto (JP)

Correspondence Address: OSHA LIANG L.L.P., 1221 MCKINNEY STREET, SUITE 2800, HOUSTON, TX, 77010, US

(73) Assignee: Omron Corporation, Kyoto (JP)

(21) Appl. No.: 10/566,828

(22) PCT Filed: Jul. 15, 2004
(86) PCT No.: PCT/JP04/10111

§ 371 Date: Jul. 5, 2006

(30) Foreign Application Priority Data
Jul. 31, 2003 (JP) 2003-283646

(51) Int. Cl. G02B 6/26

(52) U.S. Cl. 385/140; 385/25

(57) ABSTRACT

A lens array (38) is mounted on the front surface of an optical fiber array (32) holding optical fibers (35, 36) for input and emission. The lens array (38) includes: an input lens (40a) for converting a signal light (45) emitted from the optical fiber (35) into parallel light or converged light; and an output lens (40b) for converging the returned parallel light and connecting it to the optical fiber (36). A rectangular prism (34) having a form of a rectangular equilateral triangle is arranged in front of the optical fiber array (32) having the lens array (38). The signal light (45) emitted from the optical fiber (35) is totally reflected twice by the rectangular prism (34) and comes into the optical fiber (36). A transparent rectangular rotary block (33) is arranged between the lens array (38) and the rectangular prism (34). The outgoing signal light (45) and the returning signal light (45) have optical axis shifted by the rotary block (33) where the signal light passes. With this structure, it is possible to obtain a small-size variable light attenuator having a high control accuracy of the attenuation quantity of the signal light and a high resolution.

### TECHNICAL FIELD

The present invention relates to a variable optical attenuator capable of adjusting the attenuation of light.

### BACKGROUND OF THE INVENTION

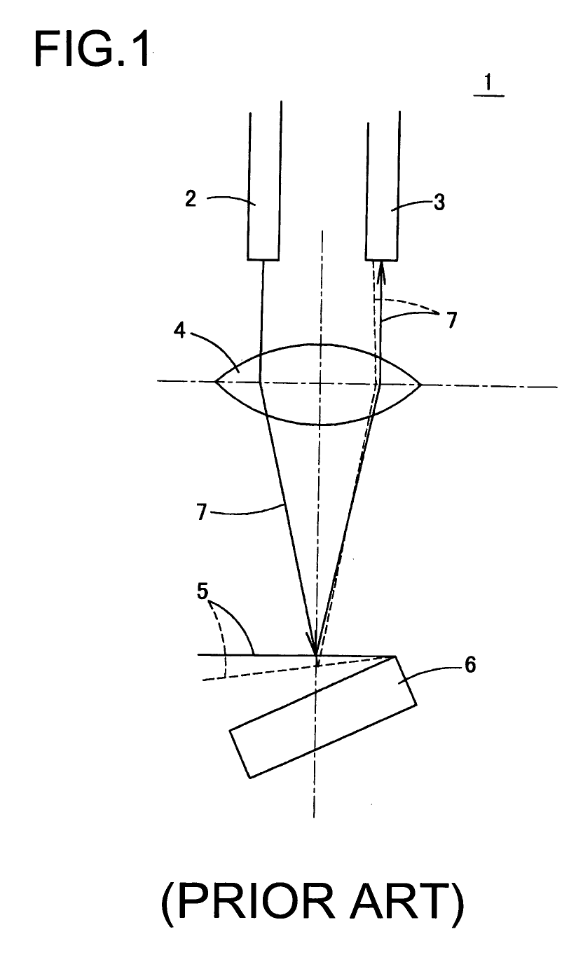

FIG. 1 is a schematic diagram illustrating the principles of a variable optical attenuator (Patent Reference 1) of traditional example 1. The variable optical attenuator 1 has input and output optical fibers 2 and 3, a lens 4, a mirror 5 which is disposed at the focus position of the lens 4, and a drive part 6 which moves the mirror 5 in the direction of the optical axis. Then, when a signal light 7 having propagated through the input optical fiber 2 comes out of the end face of the core of the input optical fiber 2, the signal light 7 passes through the lens 4 at the position off the optical axis of the lens 4, and it is transformed to a parallel luminous flux at the lens 4 as well as the direction of the signal light 7 traveling is tilted with respect to the optical axis of the lens 4. The signal light 7 having passed through the lens 4 is reflected at the mirror 5 toward the, lens 4 side, and it again passes through the lens 4 at the position off the optical axis of the lens 4. The signal light 7 having again passed through the lens 4 is gathered at the lens 4 as well as the direction of the signal light 7 traveling is bent in the direction in parallel with the optical axis of the lens 4, and the signal light is coupled to the output optical fiber 3.

In the variable optical attenuator 1, the drive part 6 controls the angle of the mirror 5 to offset the optical axis of the signal light 7 entering the output optical fiber 3 from the optical axis of the output optical fiber 3, thereby changing the optical coupling efficiency of the input optical fiber 2 to the output optical fiber 3 to allow the attenuation of the signal light 7 taken out of the output optical fiber 3 to be variable.

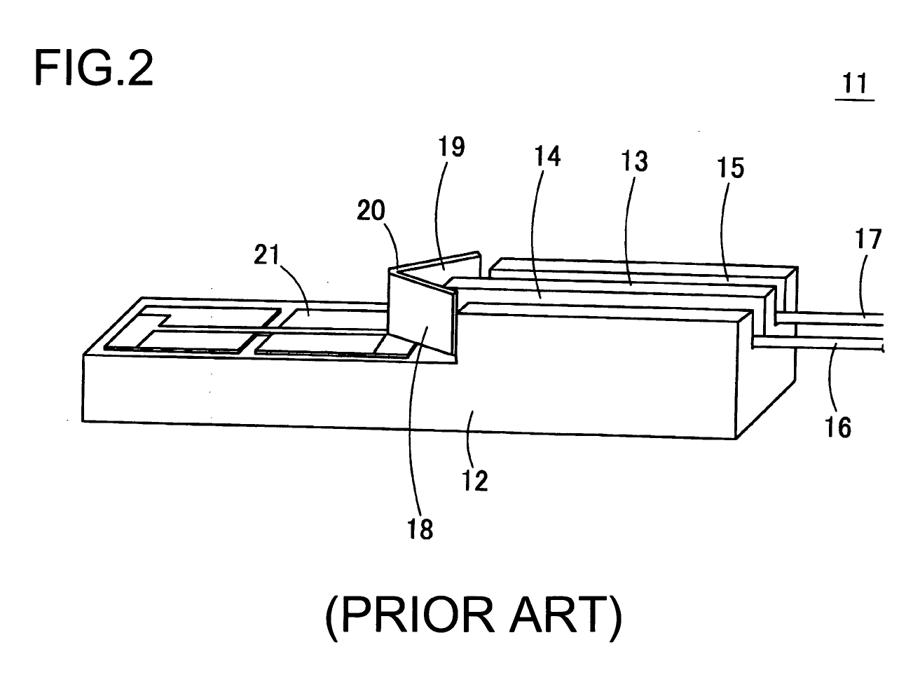

FIG. 2 is a partially broken perspective view illustrating the structure of another variable optical attenuator (Patent Reference 2) of traditional example 2. In this variable optical attenuator 11, two grooves 14 and 15 are cut open on the top face of a support part 12 through a shielding wall 13. An input optical fiber 16 is accommodated in the groove 14, and an output optical fiber 17 is accommodated in the groove 15, and lenses (not shown) are disposed at the end faces of the input and output optical fibers 16 and 17 accommodated in the grooves 14 and 15, respectively. A light reflector 20 formed of two mirrors 18 and 19 orthogonal to each other is supported on the top face of the support part 12 at the position one step lower than the grooves 14 and 15. The light reflector 20 is moved by an actuator 21 along the direction of the optical axis of the optical fibers 16 and 17.

Then, in the variable optical attenuator 11, a signal light having come out of the input optical fiber 16 is gathered at one lens, reflected twice at the mirrors 18 and 19 of the light reflector 20, returned to the original direction, gathered at the other lens, and coupled to the output optical fiber 17. Subsequently, the actuator 21 changes the distance between the input and output optical fibers 16 and 17 and the light reflector 20 to adjust the coupling efficiency of the input optical fiber 16 to the output optical fiber 17, allowing the attenuation of the signal light taken out of the output optical fiber 17 to be variable.

However, both of the traditional example 1 and the traditional example 2 have the structure that rotates or moves the mirror required for relative position accuracy with respect to the optical fiber. Thus, assembly and adjustment of the variable optical attenuator are difficult, and consequently there is a problem that the performance is varied. In addition, even though the mirror is adjusted correctly at the fabrication stage, the position of the mirror might be greatly varied while the mirror is repeatedly driven.

Furthermore, in the variable optical attenuator of the traditional example 1, since the offset resolution of the optical axis that decides the attenuation adjustment resolution becomes 2fξ (where f is the focal length of the lens, and ξ is the mirror angle control resolution), the value of f needs to be reduced when the mirror angle control resolution is insufficient. However, in the structure like that of the traditional example 1, lens aberration is a constraint, and thus it is difficult to realize a variable optical attenuator of high resolution and high accuracy.

Moreover, in the case of the variable optical attenuator of the traditional example 2, although it can improve control resolution by forming the outgoing luminous flux from the optical fiber into nearly collimate, a drive stroke needs to be increased in order to obtain a proper attenuation range, causing the variable optical attenuator to increase in size. In reverse, the focal length of the lens is shortened to narrow the outgoing luminous flux from the optical fiber, allowing the variable optical attenuator to reduce in size, but control resolution is degraded disadvantageously.

Patent Reference 1: JP-A-2000-131626

Patent Reference 2: JP-A-2002-221676

### DISCLOSURE OF THE INVENTION

An object of the invention is to provide a variable optical attenuator of high resolution in small size, which controls optical attenuation highly accurately.

The variable optical attenuator according to the invention is a variable optical attenuator having at least a pair of optical transmission lines optically coupled, wherein all or a part of luminous flux coming out of one optical transmission line of the paired optical transmission lines is optically coupled to the other of the paired optical transmission lines, including:

a light transmissive member is arranged in an optical path that the optical transmission lines are optically coupled so that the member is allowed to change an angle thereof. Here, for the optical transmission line, an optical fiber, an optical waveguide, etc., can be used.

In the variable optical attenuator according to the invention, the light transmissive member is disposed in the optical path that the optical transmission lines are optically coupled so that the member is allowed to change the angle thereof. Thus, the angle of the light transmissive member is changed, thereby shifting the optical axis of the luminous flux having passed through the light transmissive member. Consequently, the optical axis of the luminous flux entering the other optical transmission line is offset, and the light quantity to be coupled to the other optical transmission line can be controlled.

Furthermore, according to the variable optical attenuator of the invention, the resolution of adjusting the light quantity (or the attenuation) can be improved by thinning the thickness between the incident plane and the outgoing plane of the light transmissive member other than the resolution of controlling the angle of the light transmissive member. Thus, a variable optical attenuator of high resolution in small size can be fabricated. Moreover, because of the structure, the attenuator can also be adapted to the optical transmission line with a narrow pitch, allowing multi-channel formation.

In an aspect of the variable optical attenuator according to the invention, an angle of the light transmissive member is changed to vary at least one angle of angles that the luminous flux coming out of one optical transmission line of the paired optical transmission lines enters the light transmissive member and that it comes out of the light transmissive member.

In the aspect of the invention, the angle of the light transmissive member disposed in the optical path is changed to vary at least one angle of the angles that that the luminous flux coming out of one optical transmission line of the paired optical transmission lines enters the light transmissive member and that it comes out of the light transmissive member, thereby shifting the optical axis of the luminous flux having passed through the light transmissive member. Consequently, the optical axis of the luminous flux entering the other optical transmission line is offset, and the light quantity to be coupled to the other optical transmission line can be controlled.

In another aspect of the invention, the light transmissive member is capable of changing an angle thereof about a rotating shaft which is oriented in a direction vertical to a plane including each of optical axes of the paired optical transmission lines. In the aspect, the light transmissive member is capable of changing the angle thereof about the rotating shaft which is oriented in the direction vertical to the plane including each of the optical axes of the paired optical transmission lines. Thus, the angle of the light transmissive member is changed to highly accurately adjust the optical attenuation.

In still another aspect of the invention, a lens or a diffraction grating which controls incoming and outgoing luminous flux is disposed at a position facing an end face of the each of the optical transmission lines. In this aspect, the lens or the diffraction grating which controls incoming and outgoing luminous flux is disposed at the position facing the end face of the each of the optical transmission lines. Thus, optical loss between the optical transmission lines can be reduced.

In still yet another aspect of the invention, it includes an actuator which changes an angle of the light transmissive member. Here, the actuator is not limited particularly, but for example, a voice coil motor, an electromagnetic moor, an ultrasonic motor, an actuator fabricated using MEMS technology, a piezoelectric bimorph, etc., can be used. According to the aspect, since the actuator which changes the angle of the light transmissive member is provided, the light transmissive member can be driven by the actuator, and the attenuation can be adjusted without opening a casing of the variable optical attenuator.

In still another aspect of the invention, it includes a monitor module which senses an attenuation of luminous flux that comes out of one optical transmission line of the paired optical transmission lines and enters the other optical transmission line. According to the aspect, it includes the monitor module which senses the attenuation of the luminous flux that comes out of one optical transmission line of the paired optical transmission lines and enters the other optical transmission line. Thus, the attenuation can be adjusted while monitoring it, and the attenuation can be adjusted highly accurately.

In yet another aspect of the invention, when luminous flux passes through the light transmissive member, a plane to which luminous flux enters the light transmissive member and a plane from which luminous flux comes out of the light transmissive member are configured of planes in parallel with each other. In the aspect, when luminous flux passes through the light transmissive member, the plane to which luminous flux enters the light transmissive member and the plane from which luminous flux comes out of the light transmissive member are configured of the planes in parallel with each other. Thus, even though the position of the light transmissive member is shifted in position so that the member is in parallel motion in a given direction, the attenuation can be prevented from being affected. Therefore, requirements for assembly accuracy of the variable optical attenuator can be relaxed, and the assembly of the variable optical attenuator can be facilitated.

In still another aspect of the invention, it includes two or more pairs of optical transmission lines optically coupled,

wherein a single light transmissive member is disposed so as to intersect across individual optical paths which optical couple the paired optical transmission lines to each other. According to the aspect, in the case where two or more optical transmission lines optically coupled are provided, a single light transmissive member is disposed so as to intersect across individual optical paths which optical couple the paired optical transmission lines to each other. Thus, the attenuation of a plurality of pairs of the optical transmission lines can be adjusted collectively.

In yet another aspect of the invention, it includes two or more pairs of optical transmission lines optically coupled,

wherein a light transmissive member is disposed separately in individual optical paths which optical couple the paired optical transmission lines to each other. According to the aspect, the light transmissive member is disposed separately in the individual optical paths which optical couple the paired optical transmission lines to each other. Therefore, the attenuation among a plurality of pairs of the optical transmission lines can be adjusted individually.

In still another aspect of the invention, it includes two or more pairs of optical transmission lines optically coupled,

wherein when luminous flux passes through the light transmissive member, at least one plane of a plane to which luminous flux enters the light transmissive member and a plane from which luminous flux comes out of the light transmissive member is a curved face or a bent face. In the aspect, when two or more optical transmission lines optically coupled are provided, at least one plane of the plane to which luminous flux enters the light transmissive member and the plane from which luminous flux comes out of the light transmissive member is formed of a curved face or a bent face. Thus, the profile of the curved face or the bent face can change the attenuation at each of the optical transmission lines by a given ratio.

In yet another aspect of the invention, the individual optical transmission lines are disposed in parallel with each other and in one piece,

the attenuator has an optical component which returns and optically couples luminous flux coming out of one optical transmission line of the paired optical transmission lines to the other optical transmission line of the paired optical transmission lines, and

the light transmissive member is disposed between each of the optical transmission lines and the returning optical component. For the returning optical component, a mirror member having at least two reflecting surfaces, a rectangular prism, a roof-shaped prism, etc., are included. In the aspect, the individual optical transmission lines are disposed in parallel with each other and in one piece, the attenuator has the optical component which returns and optically couples luminous flux coming out of one optical transmission line of the paired optical transmission lines to the other optical transmission line of the paired optical transmission lines, and the light transmissive member is disposed between each of the optical transmission lines and the returning optical component. Therefore, the individual optical transmission lines can be collected at one side, and the variable optical attenuator can be reduced in size. Furthermore, since the individual optical transmission lines are formed in one piece, the optical transmission line can be handled easily.

In still another aspect of the invention, in the aspect having the returning optical component, when luminous flux passes through the light transmissive member, a plane to which luminous flux enters the light transmissive member and a plane from which luminous flux comes out of the light transmissive member are both configured of planes, and

the plane from which luminous flux comes out is tilted with respect to the plane to which luminous flux enters. According to the aspect, the plane to which luminous flux enters the light transmissive member and the plane from which luminous flux comes out of the light transmissive member are both configured of planes, and the plane from which luminous flux comes out is tilted with respect to the plane to which luminous flux enters. Thus, the relationship between the rotation angle of the light transmissive member and the attenuation can be close to a straight line.

In yet another aspect of the invention, in the aspect having the returning optical component, luminous flux coming out of one optical transmission line of the paired optical transmission lines passes through twice the light transmissive member in an optical path from one optical transmission line toward the returning optical component and in an optical path that is reflected at the returning optical component toward the other optical transmission line of the paired optical transmission lines. According to the aspect, the luminous flux coming out of one optical transmission line of the paired optical transmission lines passes through twice the light transmissive member in the optical path from one optical transmission line toward the returning optical component and in the optical path that is reflected at the returning optical component toward the other optical transmission line of the paired optical transmission lines. Therefore, a change in the attenuation with respect to a fixed angle of the light transmissive member can be made great.

In still another aspect of the invention, in the aspect having the returning optical component, luminous flux coming out of one optical transmission line of the paired optical transmission lines passes through twice the light transmissive member in an optical path from one optical transmission line toward the returning optical component and in an optical path that is reflected at the returning optical component toward the other optical transmission line of the paired optical transmission lines, and when luminous flux passes through the light transmissive member, a plane to which luminous flux enters the light transmissive member and a plane from which luminous flux comes out of the light transmissive member are configured of planes in parallel with each other. In the aspect having the returning optical component, the light transmissive component is passed twice in the going optical path and the returning optical path. The plane to which luminous flux enters the light transmissive member and the plane from which luminous flux comes out of the light transmissive member are configured of planes in parallel with each other. Thus, even though the rotating shaft of the light transmissive member is tilted or the light transmissive member is shifted in position so that it is in parallel motion, the attenuation can be prevented from being affected. Accordingly, requirements for assembly accuracy of the variable optical attenuator can be relaxed, and the assembly of the variable optical attenuator can be facilitated.

In yet another aspect of the invention, in the aspect having the returning optical component, it includes two or more pairs of optical transmission lines optically coupled,

wherein the individual optical transmission lines are arranged in a line at a constant pitch. In the aspect, two or more pairs of optical transmission lines optically coupled and arranged in parallel with each other are arranged in a line at a constant pitch. Therefore, the variable optical attenuator can be reduced in profile.

In still another aspect of the invention, in the aspect having the returning optical component, it includes two or more pairs of optical transmission lines optically coupled,

one optical transmission line of each of the paired optical transmission lines is arranged in a line, and the other optical transmission line of each of the paired optical transmission lines is arranged in a line, and

an arranged direction of one optical transmission line and an arranged direction of the other optical transmission line are in,parallel with each other. In the aspect, one optical transmission line of each of the paired optical transmission lines is arranged in a line, and the other optical transmission line of each of the paired optical transmission lines is arranged in a line, and an arranged direction of one optical transmission line and an arranged direction of the other optical transmission line are in parallel with each other. Thus, the optical transmission line can be disposed in two stages, and the combined optical transmission lines can be made compact. Moreover, the light transmissive member used here can also be reduced in size, and the variable optical attenuator can be more reduced in size.

In addition, the components of the invention described above can be combined freely as much as possible.

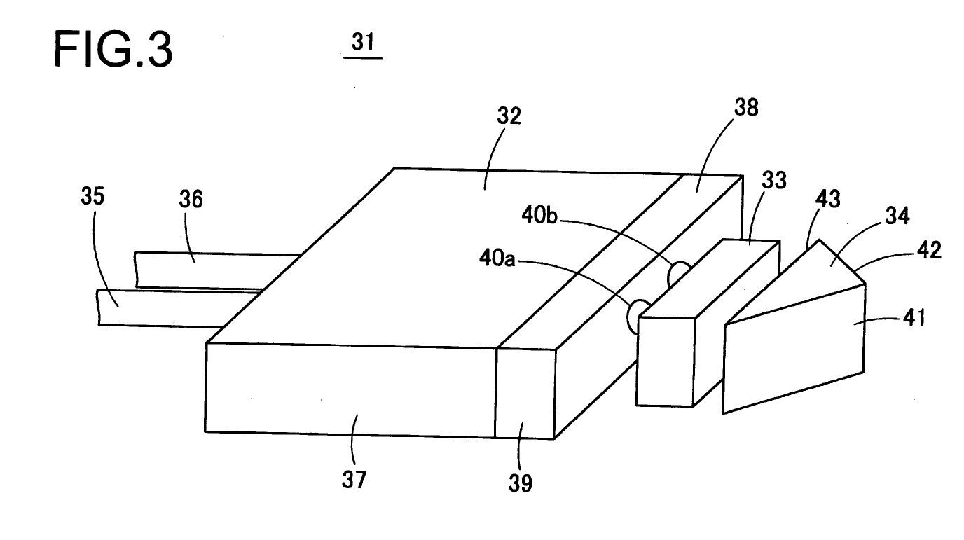

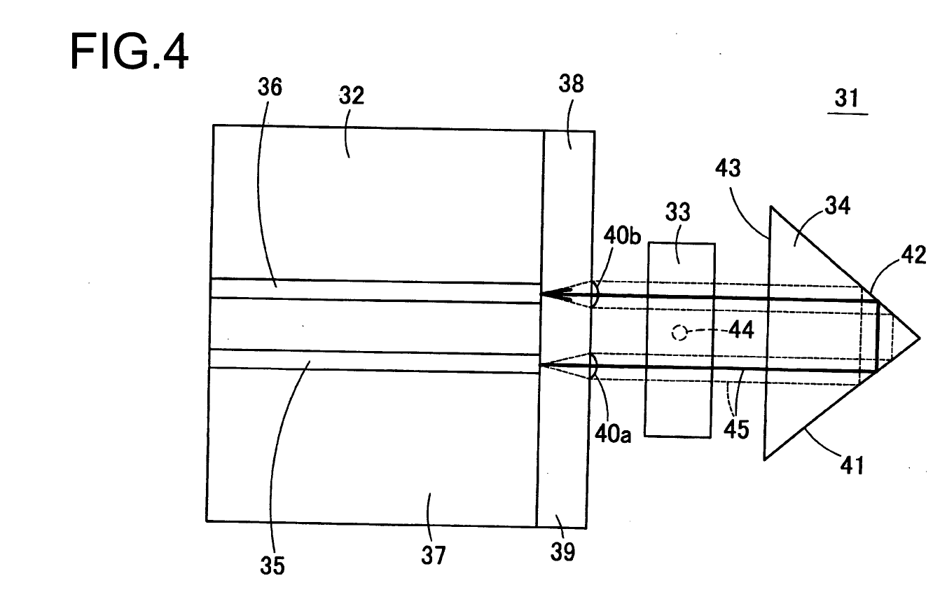

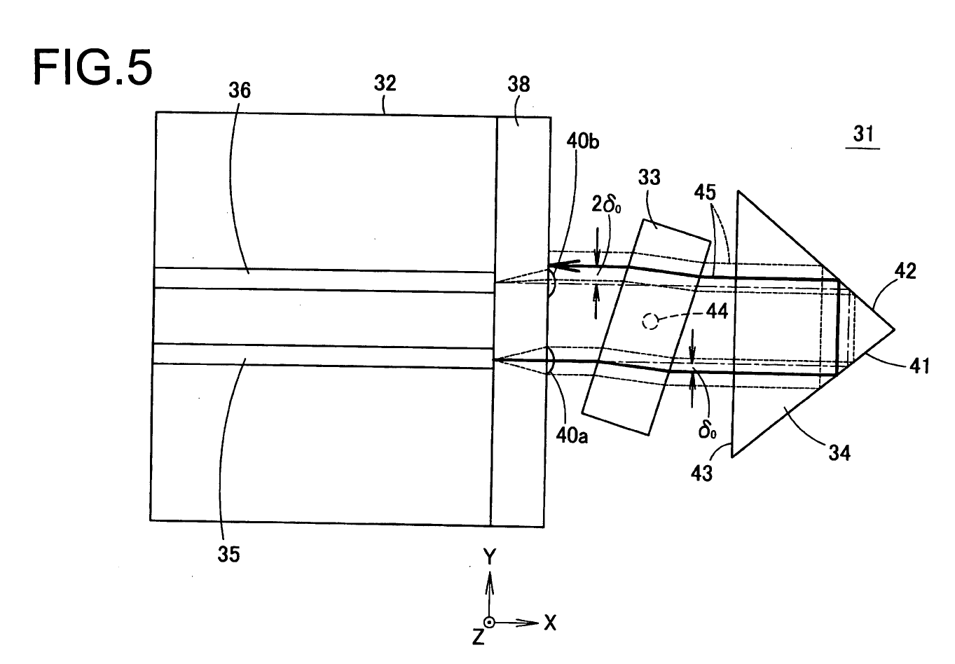

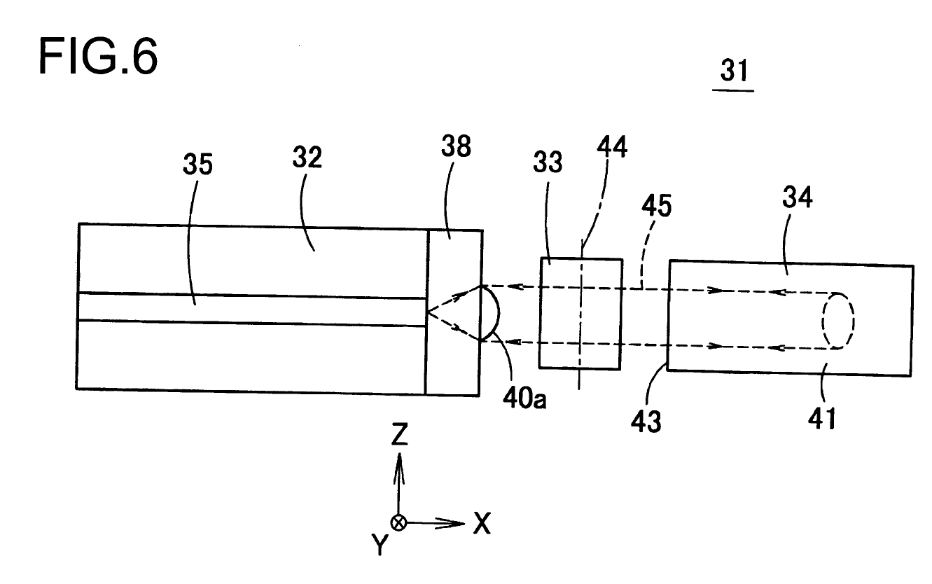

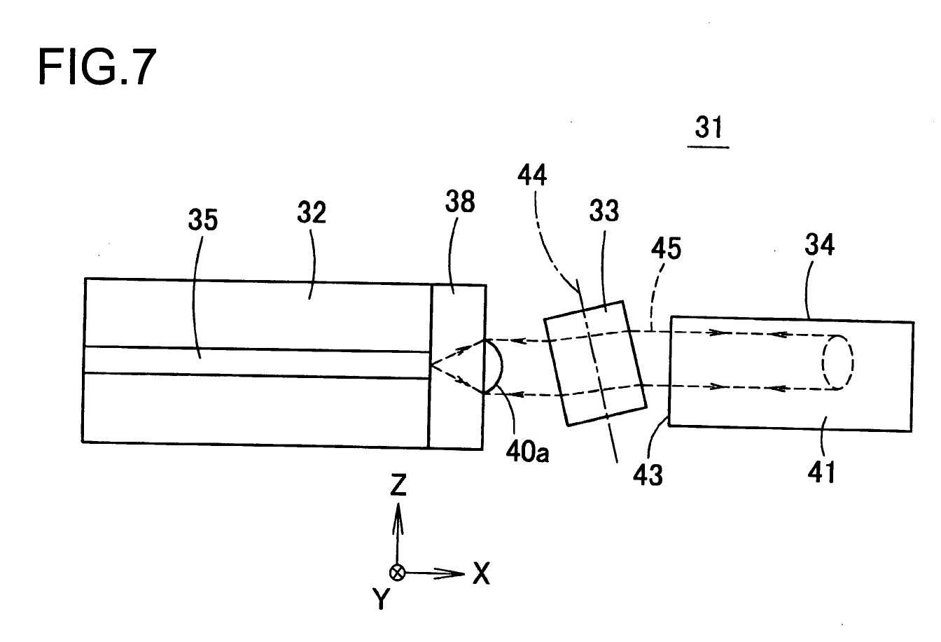

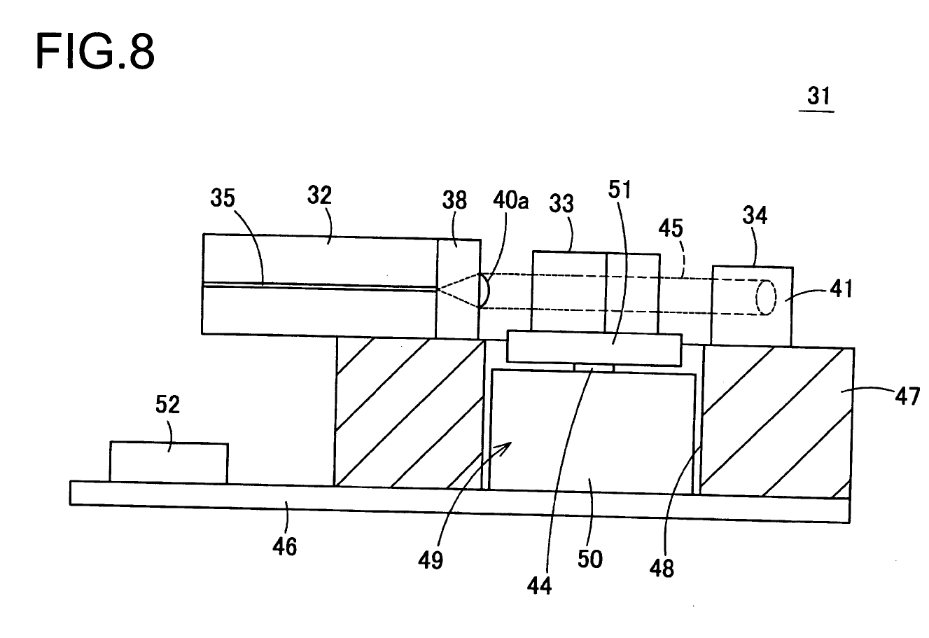

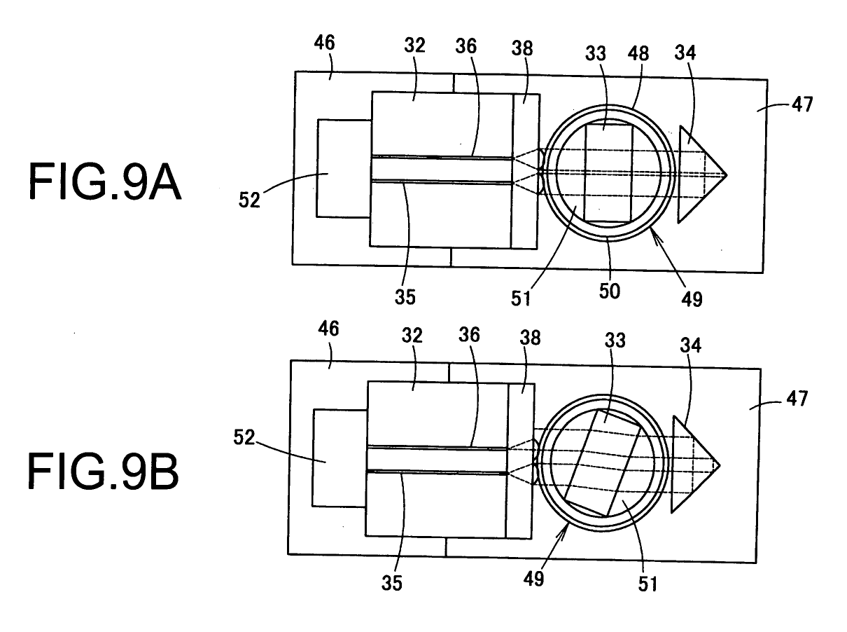

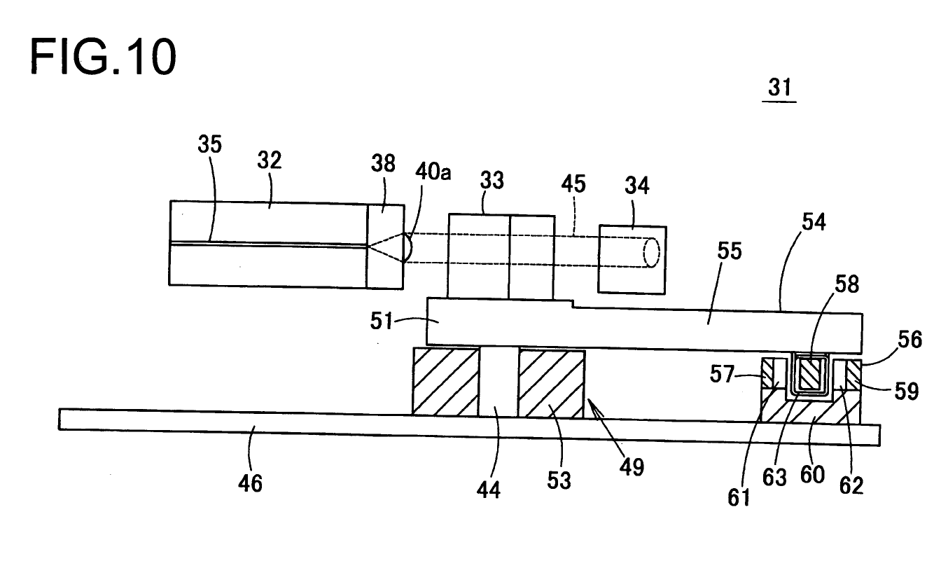

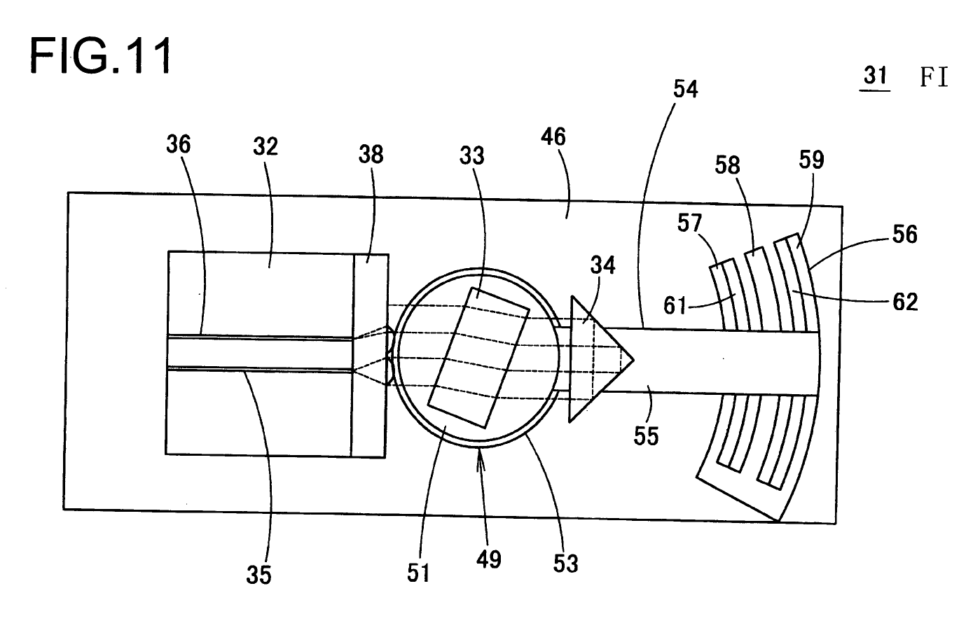

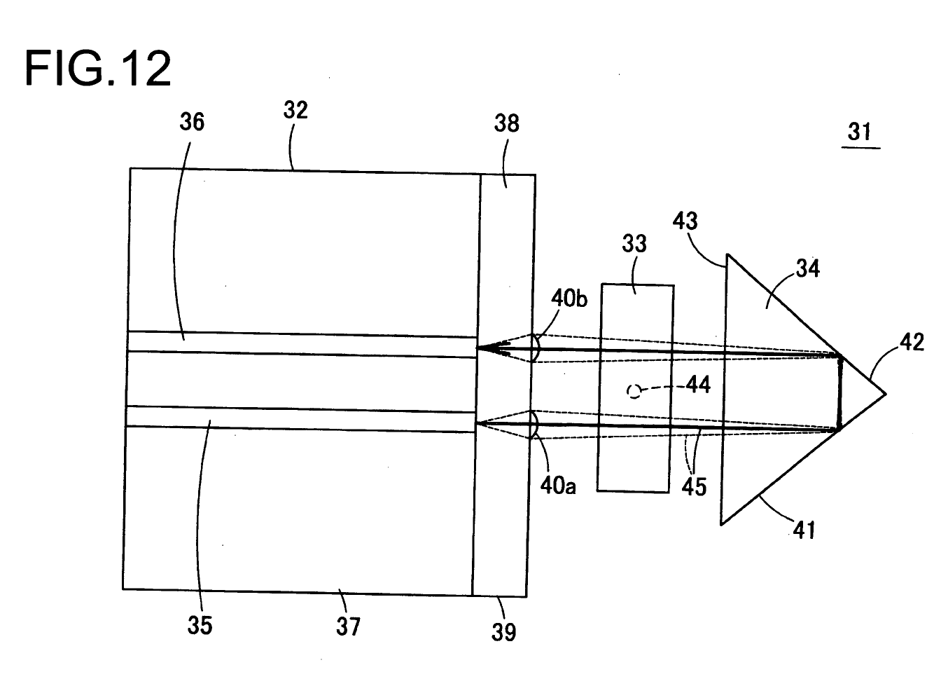

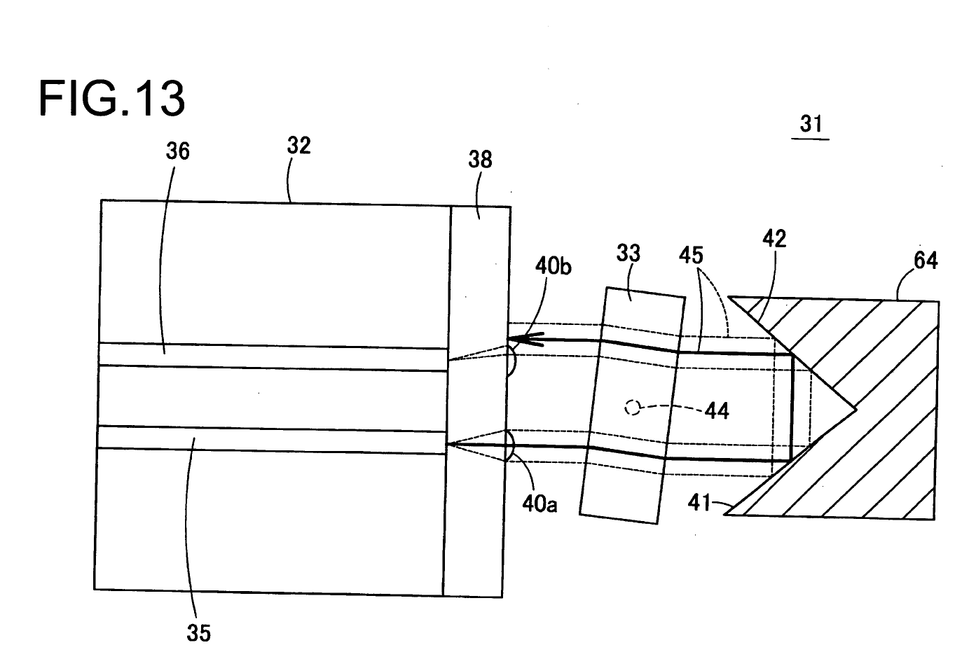

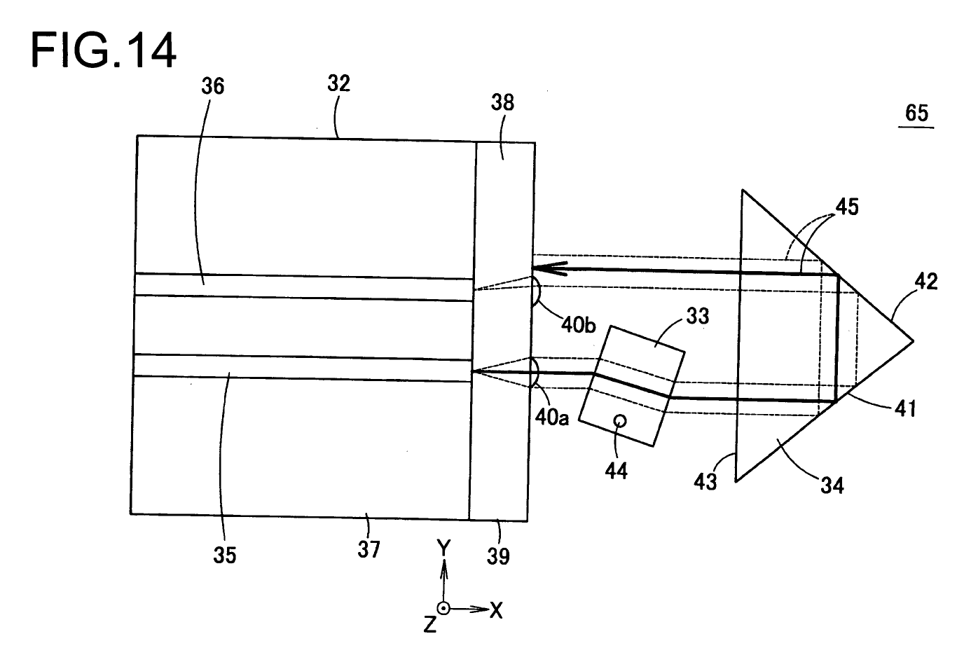

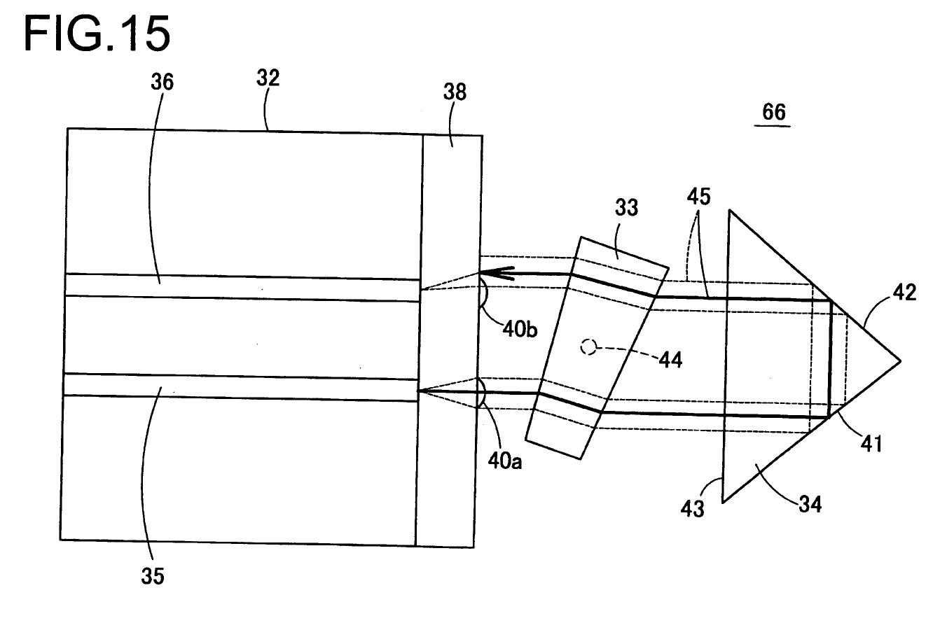

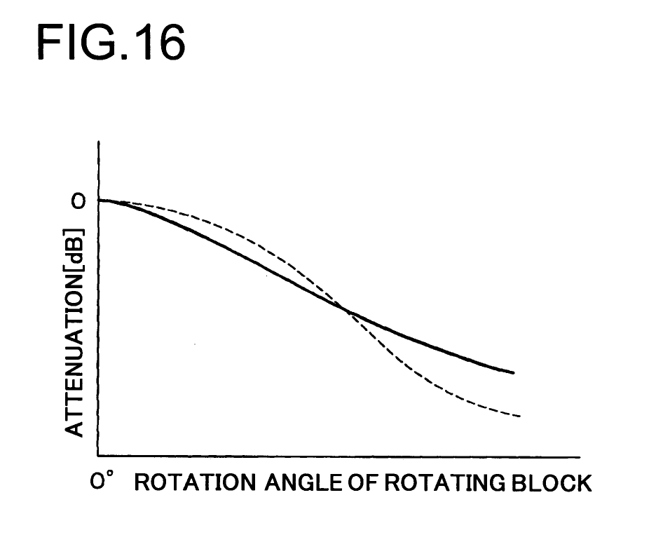

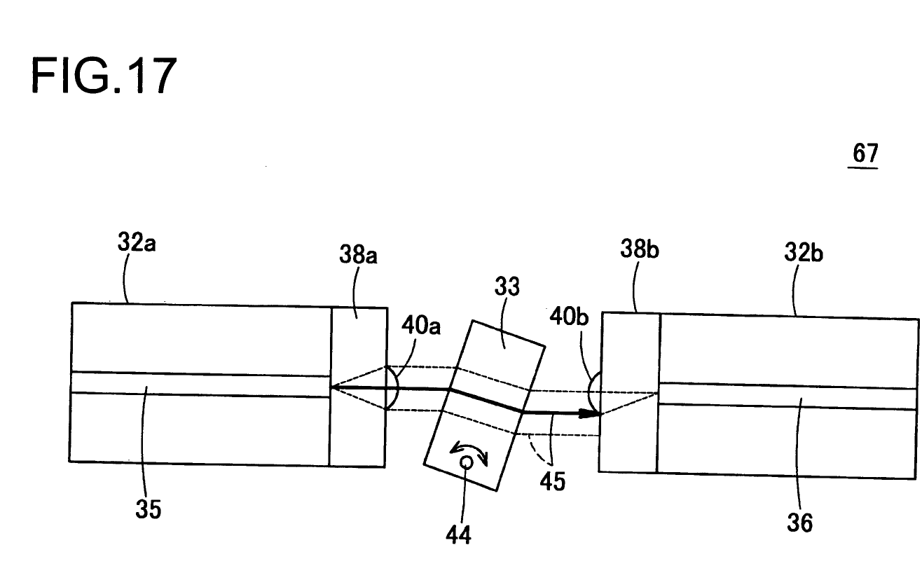

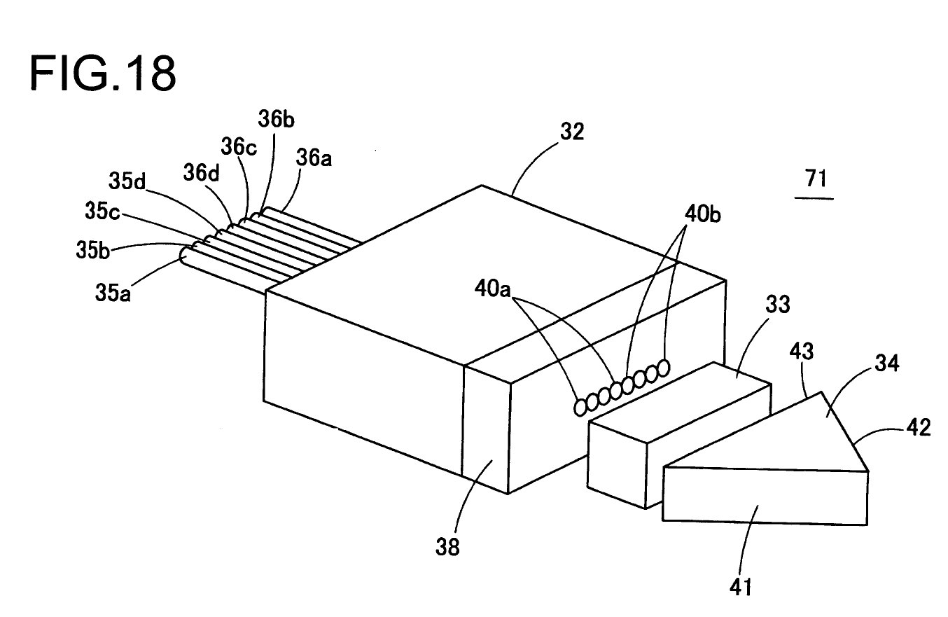

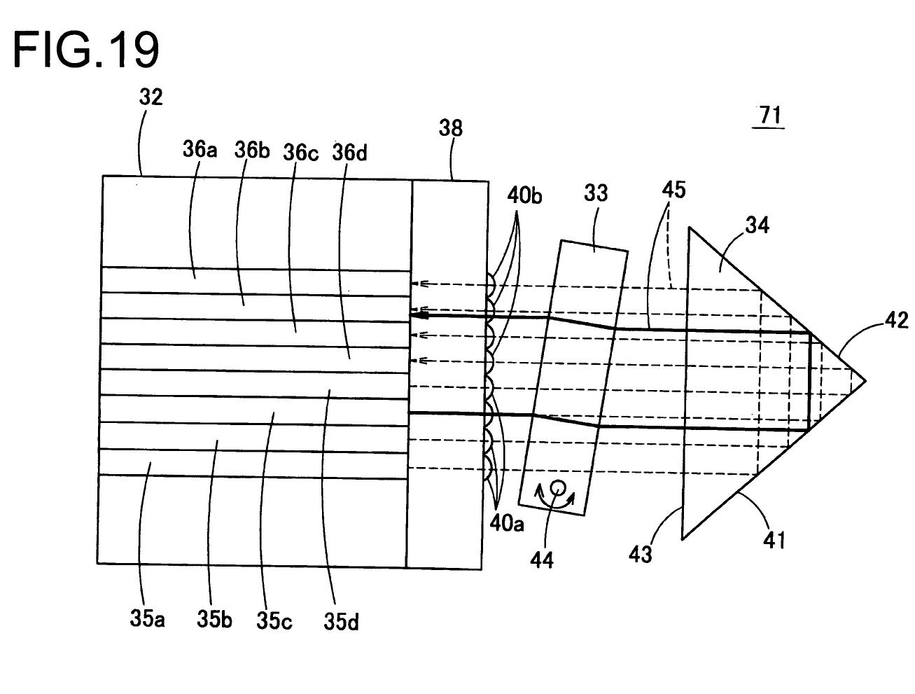

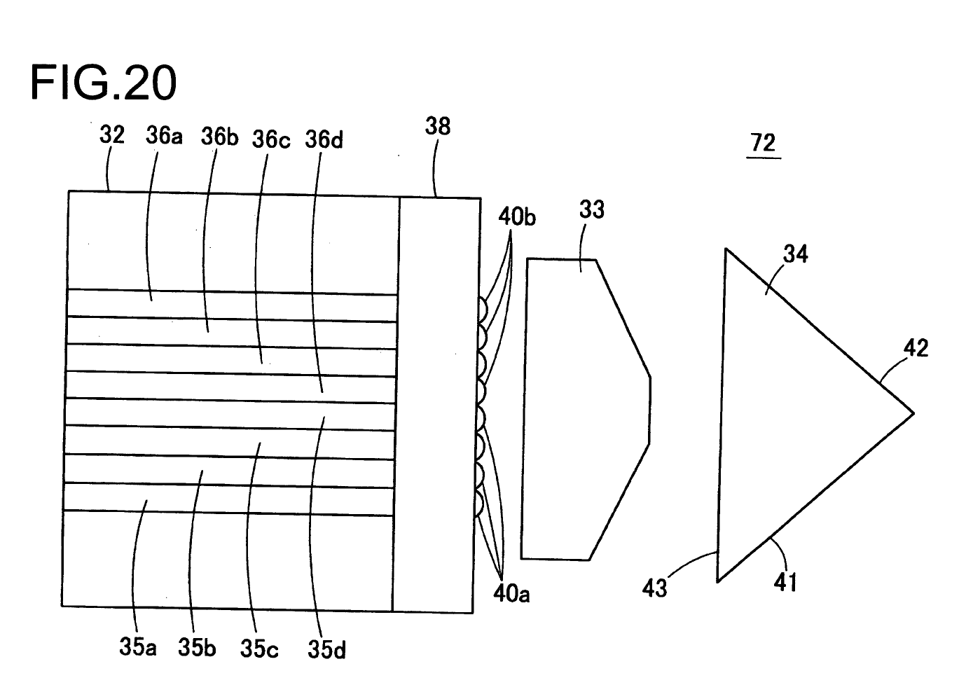

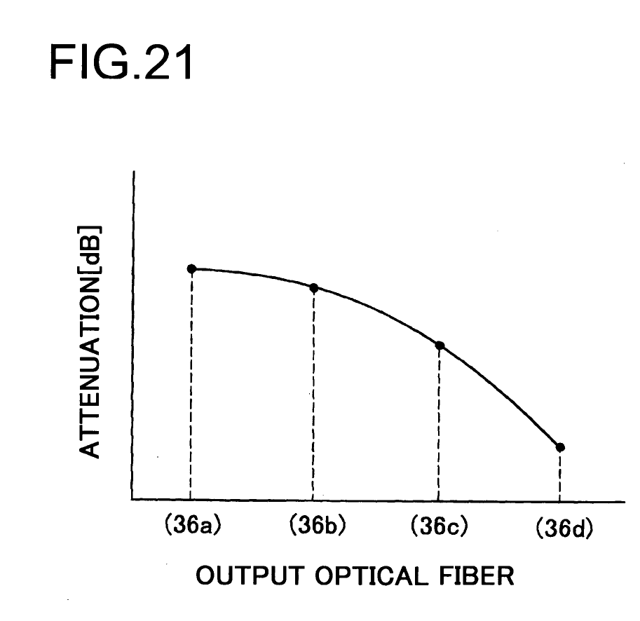

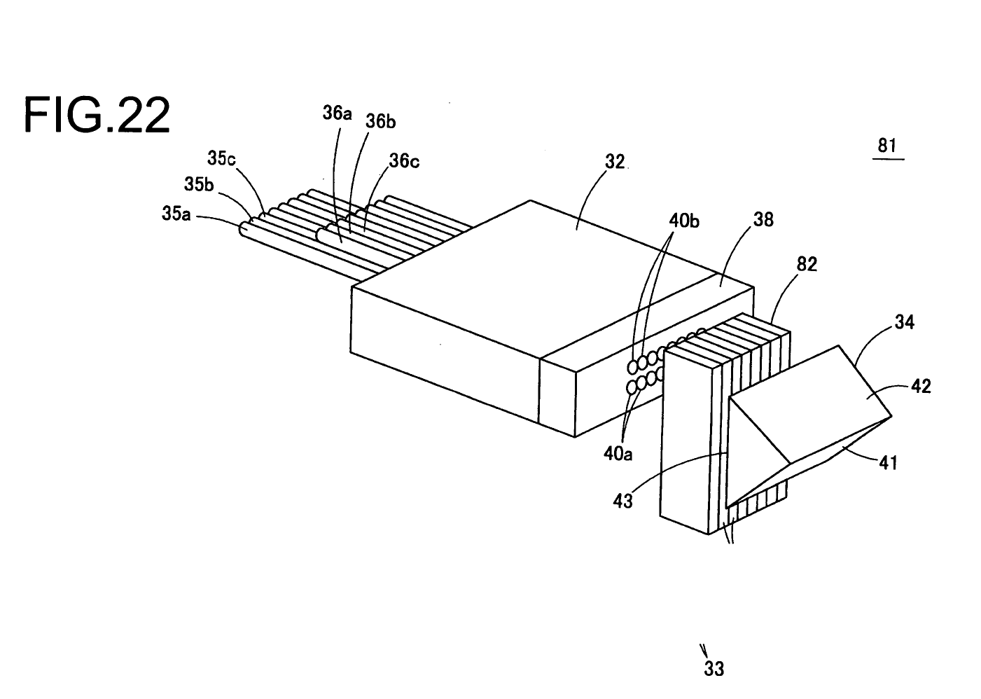

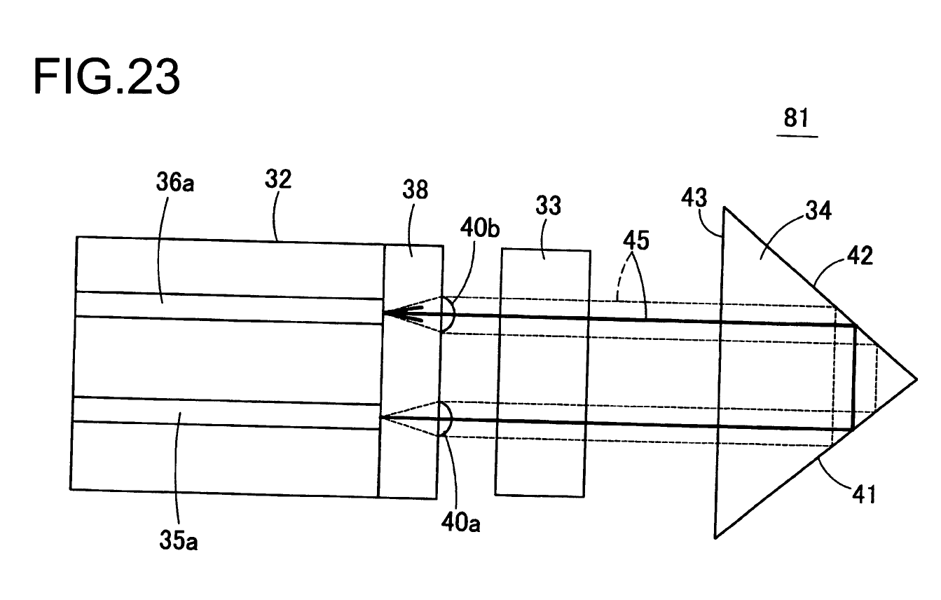

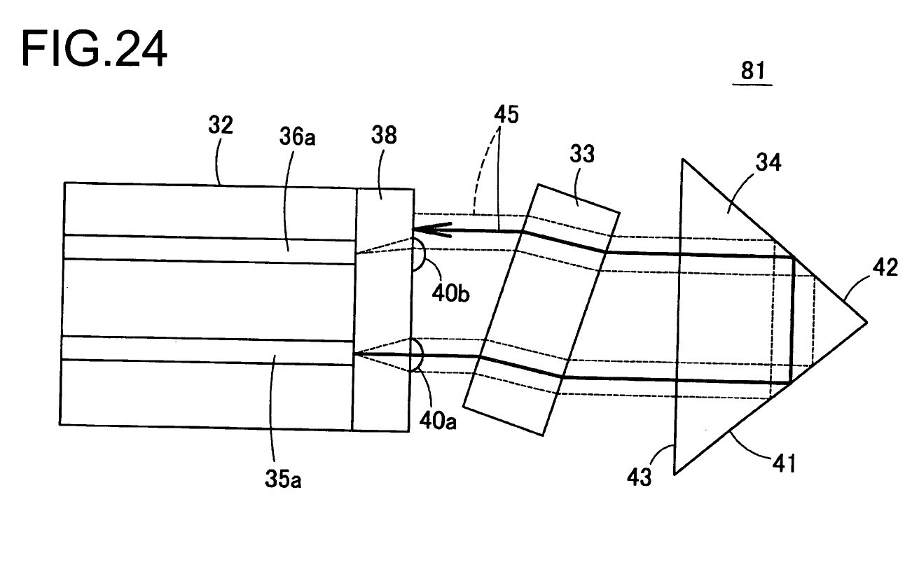

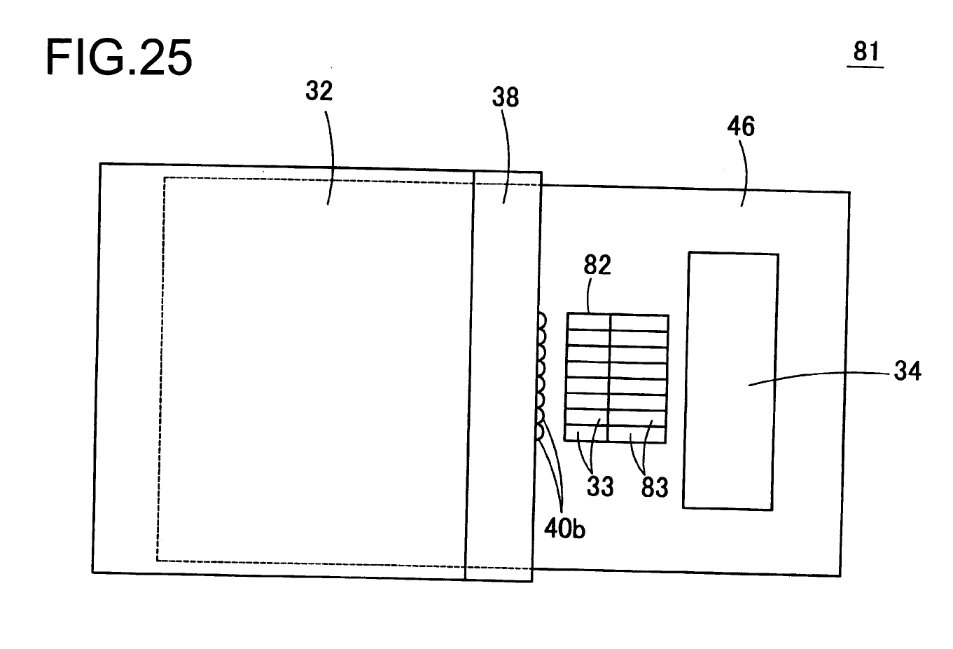

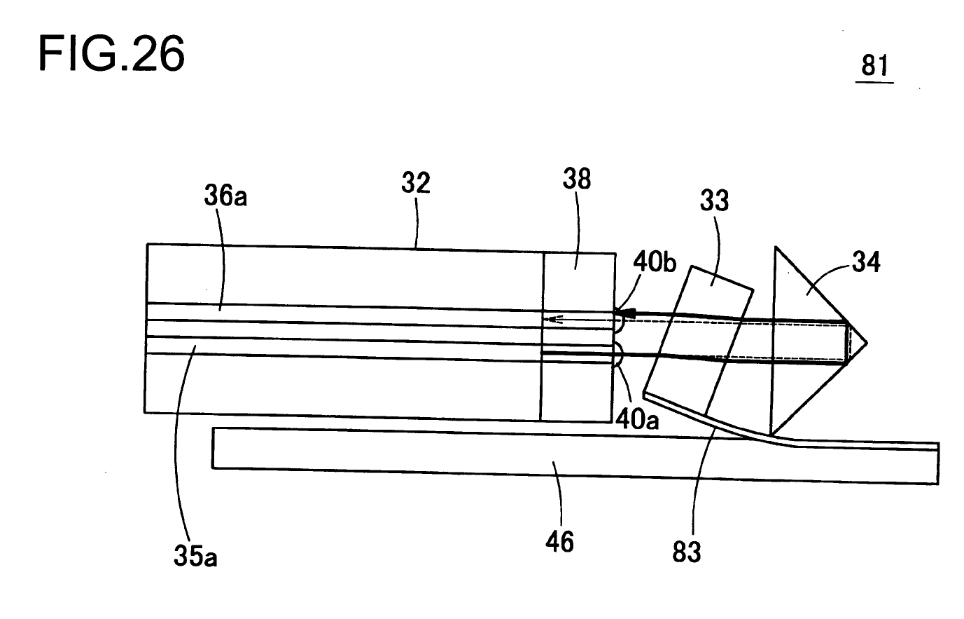

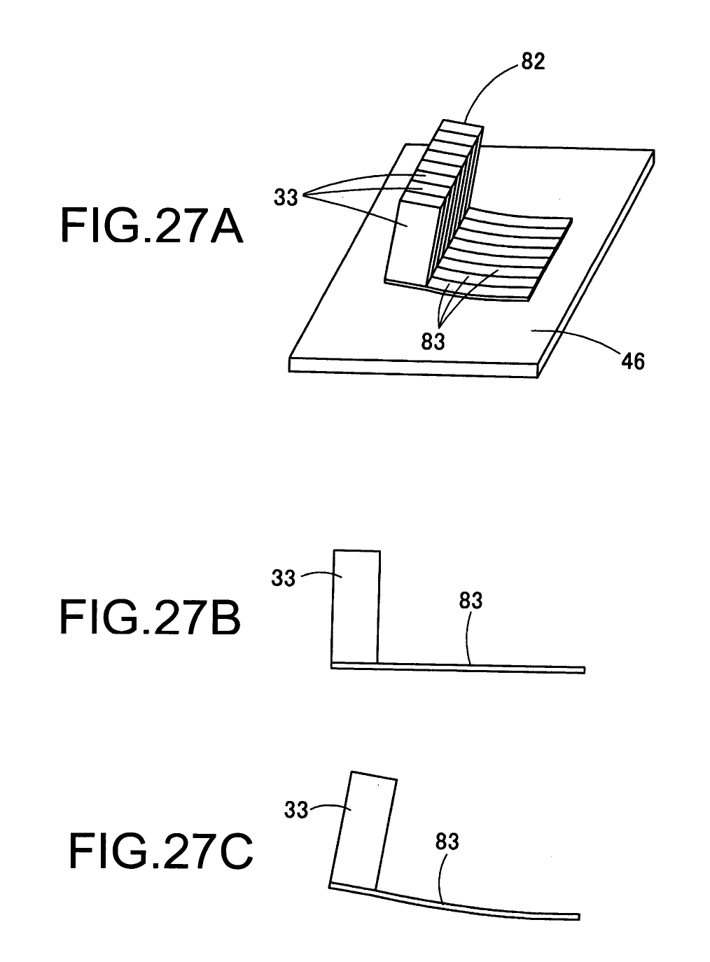

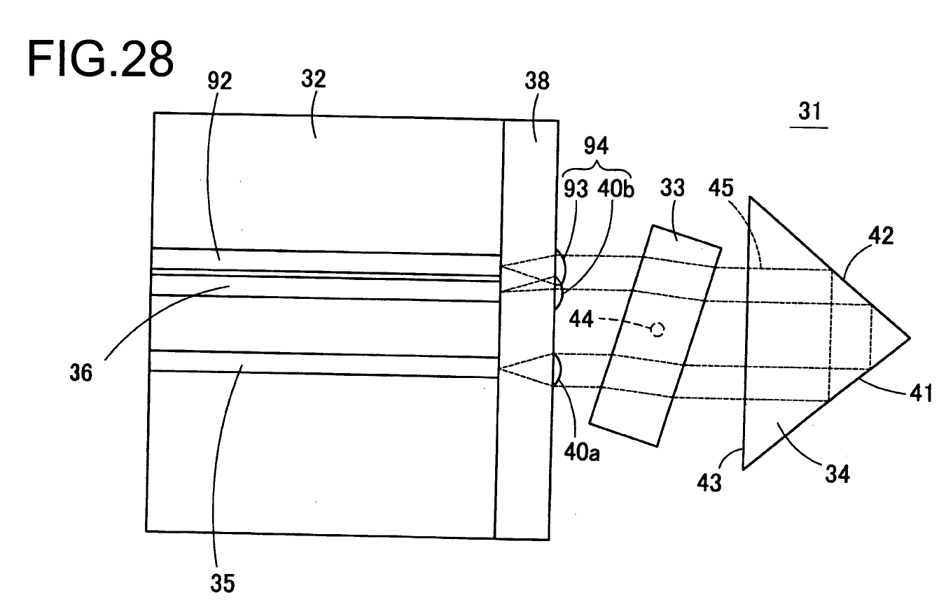

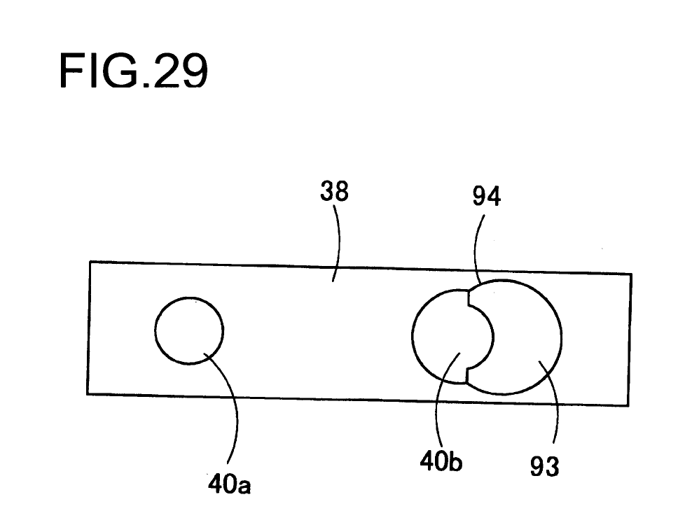

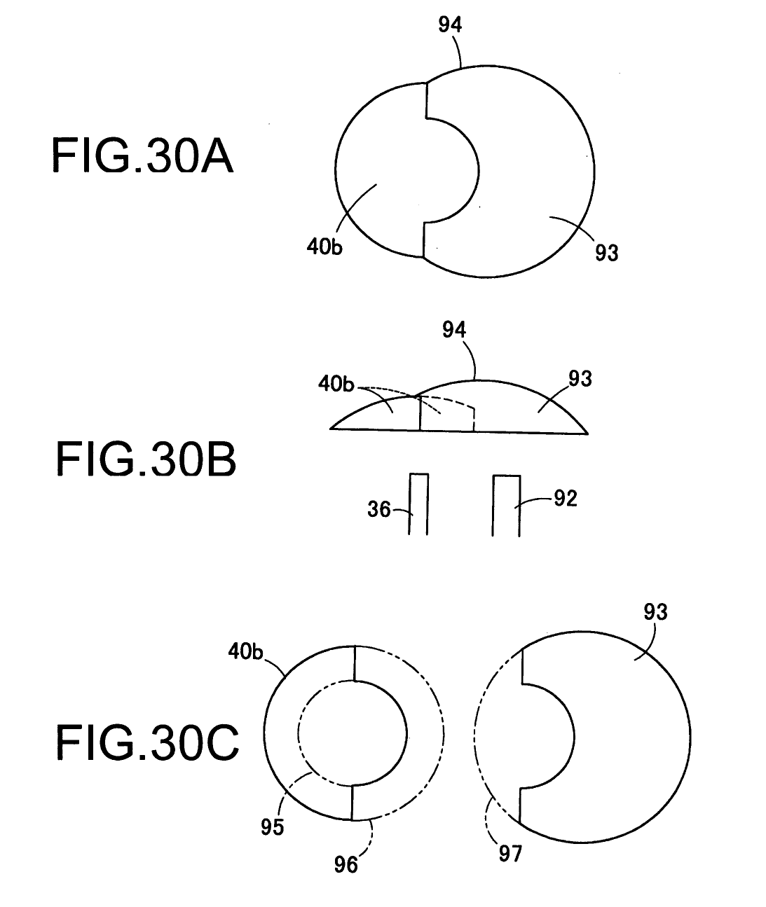

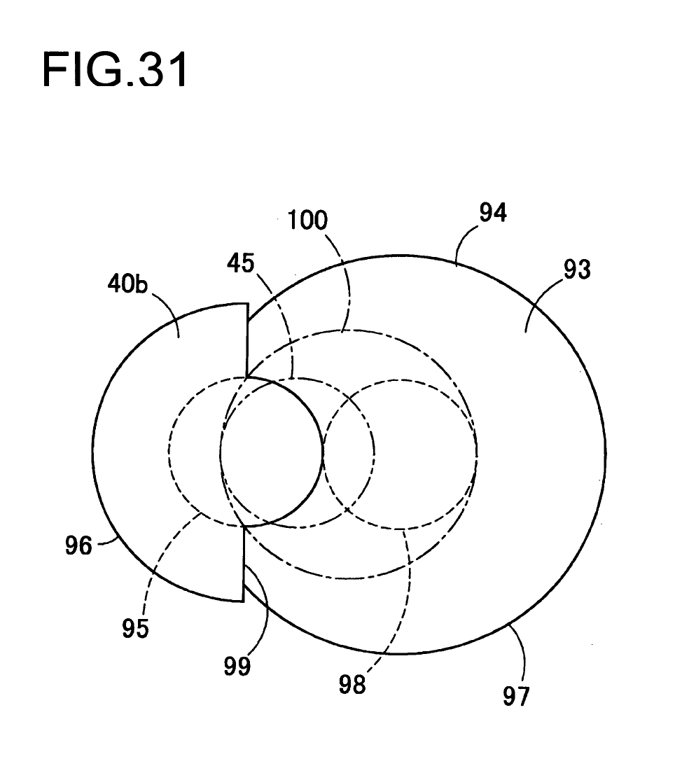

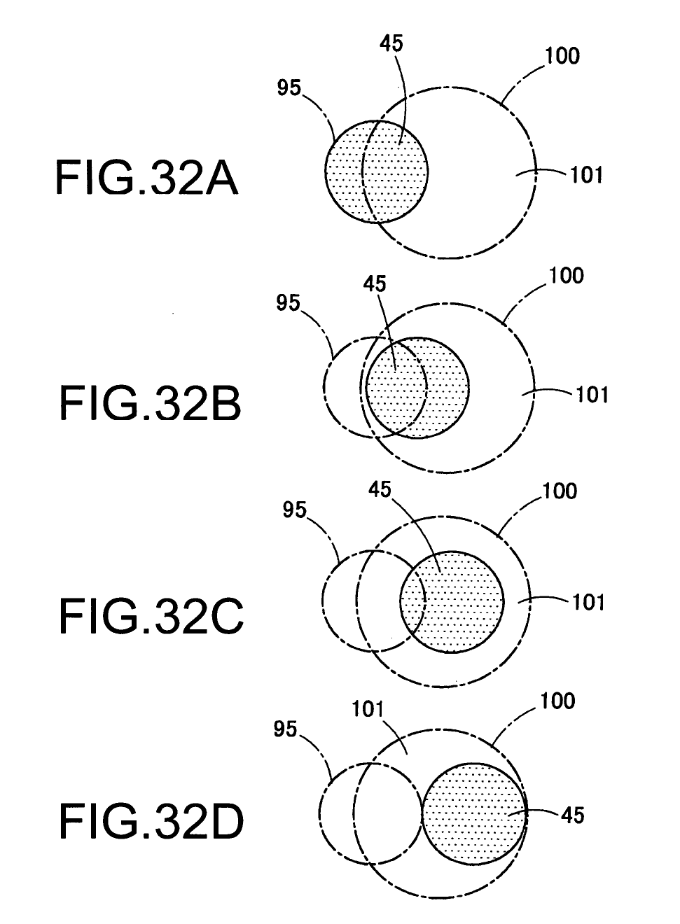

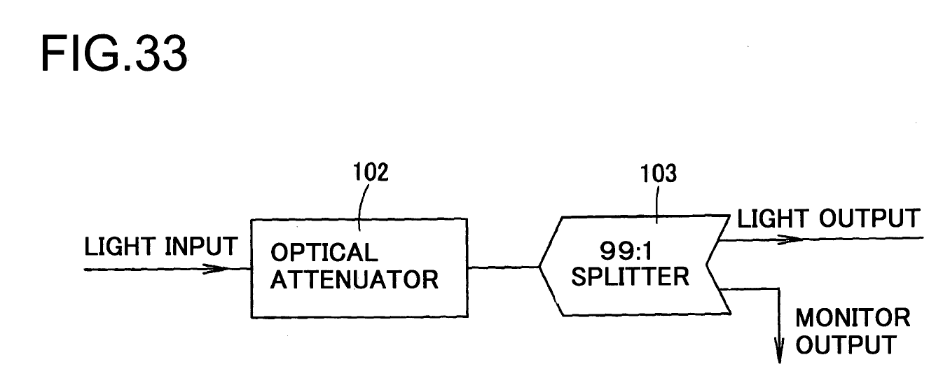

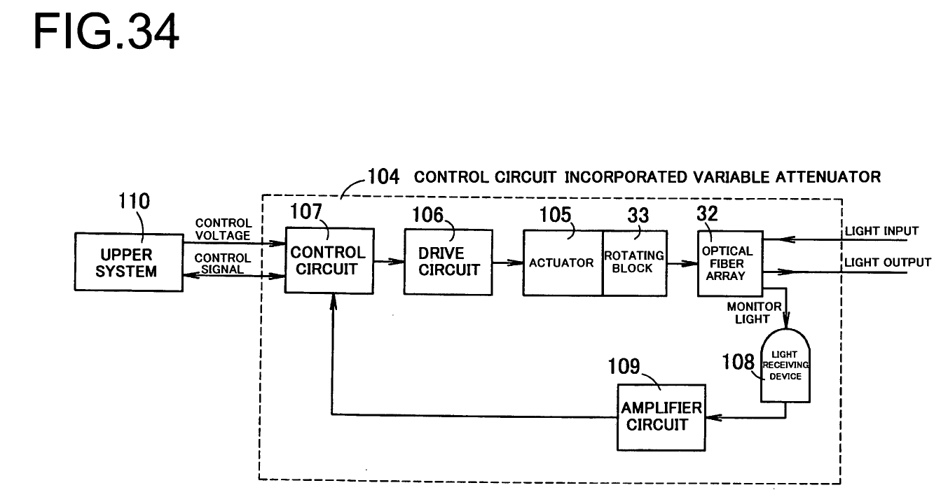

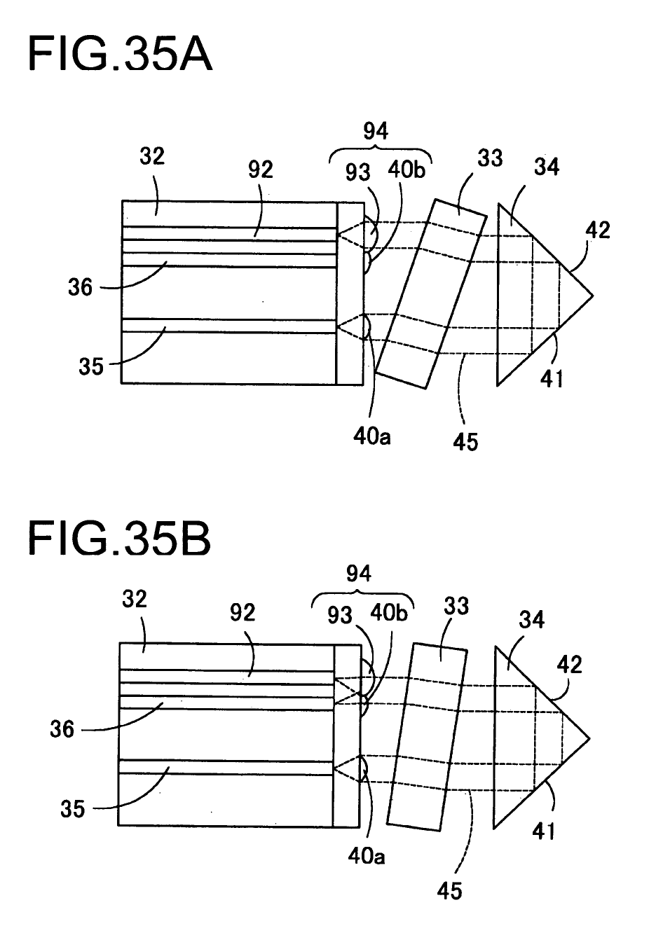

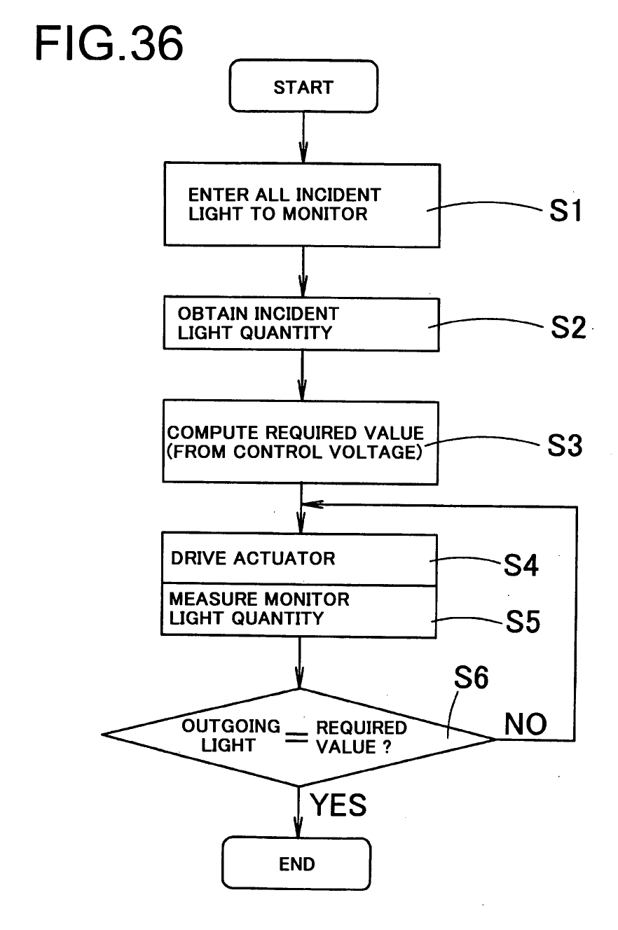

### BRIEF DESCRIPTION OF THE DRAWINGS

[FIG. 1] It is a schematic diagram illustrating the principles of the variable optical attenuator of the traditional example 1.

[FIG. 2] It is a schematic perspective view illustrating the variable optical attenuator of the traditional example 2.

[FIG. 3] It is a perspective view illustrating the structure of a variable optical attenuator of Embodiment 1 according to the invention.

[FIG. 4] It is a horizontal cross section illustrating the variable optical attenuator above.

[FIG. 5] It is a horizontal cross section illustrative of the operation of the variable optical attenuator in FIG. 3.

[FIG. 6] It is a vertical cross section illustrating the variable optical attenuator in FIG. 3.

[FIG. 7] It is a vertical cross section illustrative of the behavior of a signal light when the rotating shaft of a rotating block is tilted from the Z-axis direction.

[FIG. 8] It is a cross section illustrating an exemplary prism rotating unit of a variable optical attenuator.

[FIG. 9](a) is a plan view illustrating a state that a rectangular prism is rotated by the prism rotating unit above, and (b) is a plan view illustrating a state after the rectangular prism is rotated.

[FIG. 10] It is a vertical cross section illustrating another example of the prism rotating unit in the variable optical attenuator.

[FIG. 11] It is a plan view illustrating a state that a prism is rotated by the prism rotating unit above.

[FIG. 12] It is a horizontal cross section illustrating a modification of the variable optical attenuator of Embodiment 1.

[FIG. 13] It is a horizontal cross section illustrating another modification the variable optical attenuator of Embodiment 1.

[FIG. 14] It is a horizontal cross section illustrating the structure of a variable optical attenuator of Embodiment 2 according to the invention.

[FIG. 15] It is a horizontal cross section illustrating the structure of a variable optical attenuator of Embodiment 3 according to the invention.

[FIG. 16] It is a diagram illustrating the relationship between the rotation angle of the rotating block and the attenuation of the signal light in the variable optical attenuator of Embodiment 1 and the variable optical attenuator of Embodiment 3.

[FIG. 17] It is a schematic vertical cross section illustrating a variable optical attenuator of Embodiment 4 according to the invention.

[FIG. 18] It is a perspective view illustrating a variable optical attenuator of Embodiment 5 according to the invention.

[FIG. 19] It is a horizontal cross section illustrating the variable optical attenuator above.

[FIG. 20] It is a schematic horizontal cross section illustrating a modification of Embodiment 5.

[FIG. 21] It is a diagram illustrating the attenuation of signal lights propagating through each output optical fiber in the modification above.

[FIG. 22] It is a perspective view illustrating a variable optical attenuator of Embodiment 6 according to the invention.

[FIG. 23] It is a vertical cross section illustrating the variable optical attenuator above.

[FIG. 24] It is a vertical cross section illustrative of the operation of the variable optical attenuator in FIG. 22.

[FIG. 25] It is a plan view illustrating a variable optical attenuator having a plurality of actuators which drive rotating blocks.

[FIG. 26] It is a schematic vertical cross section illustrating the variable optical attenuator above.

[FIG. 27](a) is a perspective view illustrating an actuator disposed on a base substrate, (b) and (c) are diagrams illustrating manners tilting the rotating blocks by the actuators.

[FIG. 28] It is a horizontal cross section illustrating a variable optical attenuator of Embodiment 7 added with a monitor output function.

[FIG. 29] It is a front view illustrating a lens array having an input lens and a hybrid lens.

[FIG. 30](a) is a front view illustrating the hybrid lens, (b) is a bottom view illustrating the hybrid lens, and (c) is a front view illustrating an output lens and a monitor lens configuring the hybrid lens.

[FIG. 31] It is a diagram illustrative of an exemplary detailed design of the hybrid lens.

[FIG. 32](a), (b), (c) and (d) are diagrams illustrative of manners of split transition of a signal light by the hybrid lens.

[FIG. 33] It is a diagram illustrative of a traditional output monitor scheme.

[FIG. 34] It is a schematic block diagram illustrating the configuration of a control circuit incorporated variable optical attenuator using a variable optical attenuator of Embodiment 7.

[FIG. 35](a) and (b) are diagrams illustrative of a scheme of adjusting the attenuation of the signal light in the variable optical attenuator with the built-in control circuit above.

[FIG. 36] It is a flow chart illustrating control operation of the control circuit incorporated variable optical attenuator in FIG. 34.

In addition, numerals and signs mainly used in the drawings are as follows:
32 optical fiber array
33 rotating block (light transmissive member)
34 rectangular prism (returning member)
35 input optical fiber (optical transmission line)
36 output optical fiber (optical transmission line)
38 lens array
40a input lens
40b output lens
41, 42 reflecting surface
45 signal light
49 prism rotating unit
50 rotary actuator
51 rotary table
54 oscillation voice coil motor
63 coil
83 actuator
92 monitoring optical fiber
93 monitor lens
94 hybrid lens

### BEST MODE FOR CARRYING OUT THE INVENTION

Hereinafter, embodiments according to the invention will be described in detail with reference to the drawings. However, the invention will not be limited to the embodiments below, which of course can be modified within the scope of the invention without deviating from the technology concepts of the invention.

### Embodiment 1

FIG. 3 is a perspective view illustrating the structure of a variable optical attenuator 31 of Embodiment 1 according to the invention, and FIG. 4 is a cross section thereof. The variable optical attenuator 31 is mainly configured of an optical fiber array 32, a rotating block 33 with light transmissive properties, a lens array 38, and a rectangular prism 34.

The optical fiber array 32 is formed of two optical fibers connected to an optical communication line, that is, the end parts of an input optical fiber 35 and an output optical fiber 36 are spaced at a predetermined distance and arranged in parallel with each other, and then they are held and combined by a resin holder 37. The lens array 38 is mounted on the front of the holder 37. The lens array 38 is formed in which an input lens 40a (microlens) and an output lens 40b (microlens) are mounted on the surface of a transparent substrate 39, the lenses are formed of a spherical lens or an aspherical lens. The input lens 40a and the output lens 40b are arranged so that the distance between the optical axes is equal to the distance between the optical axes of the end parts of the optical fibers 35 and 36. The lens array 38 is fixed to the front face of the holder 37 with an adhesive, etc., and the optical axes of the input lens 40a and the output lens 40b are matched with the optical axes of the input optical fiber 35 and the output optical fiber 36, respectively. Furthermore, the thickness of the substrate 39 is nearly equal to the focal length of the lenses 40a and 40b, and the distance between the main plane of the lenses 40a and 40b and the end faces of the optical fibers 35 and 36 is equal to the focal length of the lenses 40a and 40b.

Here, suppose the radius of the cores of the input optical fiber 35 and the output optical fiber 36 is rc, the numerical aperture thereof is NA, and the thickness of the substrate 39 is T, the radius R of the input lens 40a and the output lens 40b is set:
R≧rc+T·tan(arc sin NA)
Therefore, the signal light having come out of the input optical fiber 35 is allowed to enter the input lens 40a at nearly 100% and to be transformed to parallel light, whereas the returned parallel light is allowed to enter the output lens 40b at nearly 100% and to enter the output optical fiber 36.

The rectangular prism 34 is produced of glass or resin having light transmissive properties, and products commercially available can be used therefor. The rectangular prism 34 has an isosceles right triangle when seen in a plane in which two planes orthogonal to each other are reflecting surfaces 41 and 42 which fully reflect light, and a plane that forms an angle of 45 degrees with respect to the reflecting surfaces 41 and 42 is an incoming and outgoing plane 43. The rectangular prism 34 is placed toward the front of the optical fiber array 32 so that the incoming and outgoing plane 43 is placed orthogonal to each of the optical axes of the optical fibers 35 and 36, the reflecting surface 41 is positioned as extended from the optical axis of the input optical fiber 35, and the reflecting surface 42 is positioned as extended from the optical axis of the output optical fiber 36.

The rotating block 33 is a block made of resin or glass having light transmissive properties, which is disposed between the lens array 38 on the front face of the optical fiber array 32 and the rectangular prism 34. The rotating block 33 is rotatably disposed about a rotating shaft 44 in parallel in the direction (vertical direction) where the rectangular prism 34 is seen in an isosceles right triangle. Moreover, in the Embodiment 1, the rotating block 33 has planes that the plane facing the lens array 38 (the front face) is in parallel with the plane facing the rectangular prism 34 (the back face), preferably formed in a rectangular parallelepiped. Furthermore, in the Embodiment 1, the rotating block 33 is placed so as to extend across the extension of the optical axis of the input optical fiber 35 and the extension of the optical axis of the output optical fiber 36. The rotating block 33 can be rotated about the rotating shaft 44 manually or with the use of an actuator (the specific example of the actuator will be described later), and can be fixed as its angel is adjusted.

However, as shown in FIG. 4, when the rotating block 33 is fixed at an initial set angle (that is, in the state that the front face of the rotating block 33 is in parallel with the lens array 38, and the back face of the rotating block 33 is in parallel with the incoming and outgoing plane 43 of the rectangular prism 34), as shown in FIG. 4, a signal light 45 that has propagated through the input optical fiber 35 and has come out of the end face of the core of the input optical fiber 35 is transformed to parallel light at the input lens 40a, the signal light 45 formed into the parallel light passes through the rotating block 33 straight, and enters the rectangular prism 34 from the incident and outgoing plane 43. The signal light 45 having entered the rectangular prism 34 fully reflects twice at the reflecting surfaces 41 and 42, and returns in the original direction. It again passes through the rotating block 33 straight to enter the output lens 40b, and it is coupled to the output optical fiber 36. In this case, the optical coupling efficiency of the input optical fiber 35 to the output optical fiber 36 becomes nearly 100%, that is, the attenuation becomes almost 0 dB.

On the other hand, as shown in FIG. 5, when the rotating block 33 is rotated about the rotating shaft 44 (the rotating shaft 44 is in parallel with the Z-axis direction in FIG. 5) and is tilted from the initial set angle, the signal light 45 having come out of the input optical fiber 35 is transformed to parallel light at the input lens 40a, the signal light 45 in parallel light passes through the rotating block 33, and is refracted twice at the front face and the back face thereof. In the signal light 45 before entering the rotating block 33 and the signal light 45 after passing therethrough, the optical axes thereof are in parallel with each other, but the optical axis is shifted by δ∘ in accordance with the tilt of the rotating block 33. Thus, the position of the signal light 45 entering the reflecting surface 41 of the rectangular prism 34 is varied. The signal light 45 fully reflects twice at the reflecting surfaces 41 and 42, returns in the original direction, and again passes through the rotating block 33. Then, the returning signal light 45 is refracted twice at the back face and the front face of the rotating block 33, and the optical axis is shifted by δ∘ toward the opposite side at the time when the going signal light 45 has passed through the rotating block 33. The signal light 45 having passed through the rotating block 33 reaches the lens array 38, only the signal light 45 having entered the output lens 40b enters the end face of the core of the output optical fiber 36, and it is coupled to the output optical fiber 36.

As apparent from FIG. 5, the position of the signal light 45 entering the output lens 40b, the light having fully reflected at the rectangular prism 34 and returned in the original direction is shifted by two times (2δ∘) the shift amount δ∘ of the optical axis due to the light passing through the rotating block 33, the returned signal light 45 only partially passes through the output lens 40b, and it is coupled to the output optical fiber 36. Therefore, the rotation angle of the rotating block 33 is varied to adjust the shift amount δ∘ of the signal light 45 passing through the rotating block 33, thereby allowing free adjustment of the optical coupling efficiency of the input optical fiber 35 to the output optical fiber 36 and the attenuation of the signal light 45.

According to the variable optical attenuator 31, the rotation angle of the rotating block 33 about the Z-axis is adjusted, and thus the attenuation of the signal light due to the variable optical attenuator 31 can be adjusted highly accurately. In addition to this, the rectangular prism 34 which requires highly accurate positioning is fixed in the variable optical attenuator 31, the assembly and adjustment of the variable optical attenuator 31 can be facilitated. Moreover, since the rectangular prism 34 does not need to be driven, there are no disadvantages such that the position of the rectangular prism 34 is shifted and adjustment becomes wrong during operation.

Furthermore, in the variable optical attenuator 31, when the width between the front face and the back face of the rotating block 33 is made small, a change in the shift amount δ∘ can be small when the rotating block 33 is rotated at an angle of 1°. Thus, resolution in adjusting the attenuation can be increased. Accordingly, resolution for adjustment of the attenuation can be increased with no increase in the size of the variable optical attenuator 31, and the variable optical attenuator 31 of high accuracy and high resolution in small size can be fabricated.

In the Embodiment 1, the front face and the back face of the rotating block 33 are in parallel with each other. Thus, as apparent from FIG. 5, even though the rotating block 33 is shifted in position (=parallel motion) such as in the direction in parallel in the direction of the optical axes of the optical fibers 35 and 36 (the X-axis direction) and in the direction vertical to the optical axes of the optical fibers 35 and 36 (that is, in the Y-axis direction in parallel with the paper surface, and in the Z-axis direction vertical to the paper surface of FIG. 5), the light quantity of the signal light that is returned from the rectangular prism 34 and coupled to the output optical fiber 36 is not affected. Therefore, the structure is made in which the adjustment of the variable optical attenuator 31 is facilitated.

Moreover, preferably, assembly is done in the variable optical attenuator 31 in which as shown in FIG. 6, the plane including the optical axes of the end parts of the optical fibers 35 and 36 and the plane vertical to the reflecting surface 41 and the reflecting surface 42 are in parallel with the same plane (X-Y plane), and the rotating shaft 44 of the rotating block 33 is vertical to the plane (in the Z-axis direction). However, in the Embodiment 1, the front face and the back face of the rotating block 33 are in parallel with each other. Thus, as shown in FIG. 7, even though the rotating shaft 44 of the rotating block 33 is tilted about the Y-axis direction, the shift of the optical axis of the going signal light 45 and the shift of the optical axis of the returning signal light 45 are cancelled. Therefore, the lens incident position of the signal light 45 that is returned from the rectangular prism 34 and coupled to the output optical fiber 36 is not affected, and the light quantity entering the output optical fiber 36 is not varied. Similarly, also when the rotating shaft 44 of the rotating block 33 is tilted about the X-axis direction, the lens incident position of the signal light 45 that is returned from the rectangular prism 34 and coupled to the output optical fiber 36 is not affected, and the light quantity entering the output optical fiber 36 is not varied.

Accordingly, in the variable optical attenuator 31 of the Embodiment 1, preciseness required in assembly of the rotating block 33 is relaxed, and the tolerance of assembly accuracy is great. Thus, assembly work is facilitated, allowing cost reductions.

Next, the actuator which rotates the rotating block 33 will be described. FIG. 8 is a schematic cross section illustrating the variable optical attenuator 31 having a prism rotating unit 49 which rotates the rotating block 33. In the variable optical attenuator 31 shown in FIG. 8, a support disc 47 is fixed to the top face of the base substrate 46, and a hollow part 48 in a well shape is disposed at the center of the support disc 47. In the hollow part 48, on the top face of the base substrate 46, a rotary actuator 50 is disposed such as an electromagnetic motor including a pulse step motor, an electrostatic motor, an ultrasonic motor, SEW, MEMS (micro electro mechanical system), etc. A rotary table 51 is horizontally supported at the top end of the rotating shaft 44 which protrudes upward from the rotary actuator 50, and the rotary table 51 is rotated and driven by the rotary actuator 50 in the horizontal plane. The optical fiber array 32 and the rectangular prism 34 are fixed to the top face of the support disc 47 so that they face to each other as the hollow part 48 is in between, and the rotating block 33 is attached and fixed to the top face of the rotary table 51 at almost the same height as the optical fiber array 32 and the rectangular prism 34. Furthermore, a drive circuit 52 which rotates and controls the rotary actuator 50 is mounted on the top face of the base substrate 46, and the prism rotating unit 49 is configured of the rotary actuator 50, the rotary table 51, the drive circuit 52, etc.

Then, suppose the rotating block 33 fixed to the rotary table 51 above the rotary actuator 50 is first at an initial set angle as shown in FIG. 9(a). When an instruction signal is sent to the drive circuit 52 from outside, as shown in FIG. 9(b), the drive circuit 52 drives the rotary actuator 50 to rotate the rotary table 51 at an angle in accordance with the instruction signal for adjusting the angle of the rotating block 33. Thus, the variable optical attenuator 31 is adjusted so as to obtain the intended attenuation.

FIG. 10 is a schematic cross section illustrating a variable optical attenuator 31 having another prism rotating unit 49, and FIG. 11 is a plan view thereof. In the variable optical attenuator 31, an oscillation voice coil motor 54 is used for the prism rotating unit 49. A cylindrical bearing 53 is disposed on the top face of a base substrate 46, and the bearing 53 rotatably supports a rotating shaft 44 disposed on the bottom face of a rotary table 51. A rotating block 33 is attached and fixed on the rotary table 51. An arm 55 (rotor plate) of the oscillation voice coil motor 54 is extended integrally from the rim of the rotary table 51. The oscillation voice coil motor 54 has a nearly E-shaped yoke member 56 with three curved yokes (heel piece) 57, 58 and 59, and the yoke member 56 is disposed on the top face of a support part 60 fixed on the top face of the base substrate 46. A permanent magnet 61 is fixed to the rim of the yoke 57 at the slit between the yokes 57 and 58, and a magnetic field is generated from the permanent magnet 61 toward the yoke 58. Similarly, a permanent magnet 62 is fixed to the rim of the yoke 59 at the slit between the yokes 59 and 58, and a magnetic field is generated from the permanent magnet 62 toward the yoke 58. A ring-shaped coil 63 is fixed on the bottom face at the rear end part of the arm 55, and the center yoke 58 is inserted into the coil 63 so as not to touch the coil 63. Then, in the oscillation voice coil motor 54, when current is carried through the coil 63, a Lorentz force acting upon the coil 63 moves the coil 63 along the yoke 58, causing the arm 55 and the rotary table 51 to rotate about the rotating shaft 44. Moreover, when the orientation of the current flow is reversed, the arm 55 and the rotary table 51 rotate in the opposite direction. Therefore, the oscillation voice coil motor 54 is driven to change the angle of the arm 55, allowing the rotating block 33 to rotate at a given rotation angle.

Since the oscillation voice coil motor is often used for a magnetic recording apparatus such as a hard disk drive and available at low prices, the cost of the variable optical attenuator 31 can be reduced when the oscillation voice coil motor 54 is used as the prism rotating unit 49.

In addition, not shown in the drawing, the rotating block 33 may be rotated and adjusted manually. For example, the rotating block 33 may be attached and fixed on the rotary table rotatably supported, the rotary table may be manually rotated to rotate the rotating block 33, and the rotary table may be locked by a proper cramping module after adjusting rotation.

In addition, the variable optical attenuator 31 according to the Embodiment 1 can be modified variously in implementation. FIG. 12 shows a modification of the Embodiment 1. In the Embodiment 1, the signal light 45 having come out of the input optical fiber 35 is transformed to parallel light at the input lens 40a, and the parallel light returned from the rectangular prism 34 is gathered at the output lens 40b and coupled to the output optical fiber 36. On the other hand, in the modification shown in FIG. 12, a signal light 45 having come out of an input optical fiber 35 is gathered at an input lens 40a, and it passes through the rotating block 33 and fully reflects at the reflecting surface 41. After that, it is gathered at a single point at the center of the reflecting surface 41 and the reflecting surface 42, it is again diverged to enter the reflecting surface 42, it fully reflects at the reflecting surface 42, it passes through the rotating block 33 to enter the output lens 40b as diverged, and it is gathered on the end face of the core of the output optical fiber 36 at the output lens 40b. In the case of the modification like this, the distance between the main planes of the lenses 40a and 40b and the end faces of the optical fibers 35 and 36 is greater than the value of the focal length of the lenses 40a and 40b.

FIG. 13 shows another modification of the Embodiment 1. In the modification in FIG. 13, a mirror block 64 is used instead of the rectangular prism 34. For example, in the mirror block 64, a recess having two planes orthogonal to each other is formed in a metal block, and two planes are mirror polished to form reflecting surfaces 41 and 42. Alternatively, it may be formed in which two planes orthogonal to each other are formed in a block made of glass or plastic and a metal film such as aluminium and Ag is deposited thereon to form the reflecting surfaces 41 and 42.

### Embodiment 2

FIG. 14 is a horizontal cross section illustrating the structure of a variable optical attenuator 65 of Embodiment 2 according to the invention. In the variable optical attenuator 65, a rotating block 33 is positioned only on the extension of the optical axis of an input optical fiber 35, and is not positioned on the extension of the optical axis of an output optical fiber 36.

In the variable optical attenuator 65 in FIG. 14, since the rotating block 33 is rotated to shift the optical axis of a signal light 45 having come out of the end face of the core of the input optical fiber 35 in the Y-axis direction, it is fully reflected twice at the rectangular prism 34 and returned, and the optical axis of the light entering the output lens 40b is also shifted in the Y-axis direction by the same amount. Consequently, the light quantity to be coupled to the output optical fiber 36 at the output lens 40b is varied to adjust the attenuation of the variable optical attenuator 65.

In the variable optical attenuator 65 of the Embodiment 2, the rotating block 33 is inserted into only one optical path (the going optical path). Thus, as compared with the case where the rotating block 33 having the same width is inserted into the going and returning optical paths (Embodiment 1), the shift amount of the optical axis by the rotating block 33 is the same but the offset of the signal light 45 entering the output lens 40b is ½ when the rotating block 33 is rotated at the same rotation angle. Therefore, according to the variable optical attenuator 65 of the Embodiment 2, as compared with the variable optical attenuator 31 of Embodiment 1, the attenuation can be adjusted more detailedly as described above, and resolution in adjusting the attenuation is improved.

Furthermore, also in the Embodiment 2, since the front face and the back face of the rotating block 33 are in parallel with each other, the light quantity entering the output optical fiber 36 and the attenuation are not affected even though the rotating block 33 is shifted in parallel in the X-axis direction, the Y-axis direction, and the Z-axis direction in FIG. 14. However, in the case of the Embodiment 2, since the rotating block 33 is inserted into only one optical path, the optical axis of the shift of the signal light 45 is not cancelled in going and returning when the rotating block 33 is assembled as tilted about the Y-axis and the X-axis. Therefore, as compared with the Embodiment 1, accuracy is required in assembly.

In addition, here, the case is explained that the rotating block 33 is positioned only on the extension of the optical axis of the input optical fiber 35, but of course, the rotating block 33 may be positioned only on the extension of the optical axis of the output optical fiber 36.

### Embodiment 3

FIG. 15 is a horizontal cross section illustrating the structure of a variable optical attenuator 66 of Embodiment 3 according to the invention. In the variable optical attenuator 66, a rotating block 33 is a trapezoid or a fan shape when seen in plane, the front face thereof facing a lens array 38 and the back face thereof facing a rectangular prism 34 are not in parallel with each other.

When the rotating block 33 having the front face and the back face thereof in parallel with each other is used as in the variable optical attenuator 31 of the Embodiment 1, the relationship between the rotation angle of the rotating block 33 and the attenuation is wavy greatly and nonlinear as indicated by a broken line in FIG. 16. On the other hand, as the variable optical attenuator 66 shown in FIG. 15, the rotating block 33 having the front face and the back face not in parallel with each other is used to allow the relationship between the rotation angle of the rotating block 33 and the attenuation close to a straight line as indicated by a solid line in FIG. 16. Accordingly, control over the variable optical attenuator 66 can be facilitated in adjustment of the attenuation by rotating the rotating block 33 with the rotary actuator 50, etc.

### Embodiment 4

FIG. 17 is a schematic cross section illustrating a variable optical attenuator 67 of Embodiment 4 according to the invention. In the variable optical attenuator 67, a signal light 45 is not returned back with the use of the rectangular prism 34, an optical fiber array 32a is faced to optical fiber array 32b, and a rotating block 33 is disposed in the midway of the optical path between the optical fiber arrays 32a and 32b. The optical fiber array 32a holds an input optical fiber 35 which outputs the signal light 45, hand has a lens array 38a with an input lens 40a fixed on the front face thereof. The optical fiber array 32b holds an output optical fiber 36 which receives the signal light 45, and has a lens array 38b with an output lens 40b fixed on the front face thereof.

Also in the variable optical attenuator 67 like this, the rotating block 33 is rotated to shift the optical axis of the signal light 45 before and after passing through the rotating block 33. Thus, the rotating block 33 is rotated to control the light quantity entering the output optical fiber 36 of optical fiber array 32b, and to adjust the attenuation of the signal light 45.

According to the invention, also when the optical fiber arrays 32a and 32b are faced to each other in this manner, the optical fiber array 32b on the light receiving side can be disposed at the position of the rectangular prism 34, and thus an advantage is exerted that the variable optical attenuator 67 does not tend to increase in size.

### Embodiment 5

FIG. 18 is a perspective view illustrating a variable optical attenuator 71 of Embodiment 5 according to the invention, and FIG. 19 is a schematic horizontal cross section thereof. In the variable optical attenuator 71, a plurality of the end parts of input optical fibers and a plurality of the end parts of output optical fibers are arranged in parallel with each other at a constant pitch in an optical fiber array 32. The end face of each of the optical fibers is exposed at the front face of the optical fiber array 32, and a lens array 38 is fixed to the front face of the optical fiber array 32.

For the number of the input optical fibers and the output optical fibers, two or more optical fibers may be fine for input and output ones, but here, an example is taken and described that four input optical fibers 35a, 35b, 35c and 35d and four output optical fibers 36d, 36c, 36b and 36a are arranged in a line.

The lens array 38 is disposed with four input lenses 40a and four output lenses 40b matched with the individual optical fibers 35a, 35b, 35c, 35d, 36d, 36c, 36b, and 36a. The optical axis of each of the input lenses 40a is matched with the optical axis of each of the input optical fibers 35a, 35b, 35c and 35d, and the optical axis of each of the output lenses 40b is matched with the optical axis of each of the output optical fibers 36a, 36b, 36c and 36d. Furthermore, the width of the rectangular prism 34 is also wider than the entire width of eight optical fibers 35a, 35b, to 36a. The rectangular prism 34 is disposed so that a reflecting surface 41 intersects across the extension line of the optical axis of the end parts of the input optical fibers 35a, 35b, 35c and 35d, and a reflecting surface 42 intersects across the extension line of the optical axis of the end parts of the output optical fibers 36d, 36c, 36b and 36a. A rectangular rotating block 33 is also disposed so as to intersect across the extension line of the optical axis of the end parts of eight optical fibers 35a, 35b to 36a.

Then, in the variable optical attenuator 71, when the rotating block 33 is in the initial set angle, as a signal light 45 indicated by a broken line in FIG. 19, lights coming out of the end faces of the cores of the input optical fibers 35a, 35b, 35c and 35d are gathered at the individual input lenses 40a and transformed to parallel light. After that, it passes through straight the rotating block 33, enters the rectangular prism 34 to fully reflect twice at the reflecting surface 41 and the reflecting surface 42, and returns in the original direction. It again passes through straight the rotating block 33, and it is gathered at the individual output lenses 40b to enter each of the end faces of the cores of the output optical fibers 36a, 36b, 36c and 36d.

On the other hand, when the rotating block 33 is tilted from the initial set angle, for example, as the signal light 45 indicated by a solid line in FIG. 19, the signal light 45 having come out of the input optical fiber 35c is shifted in its optical axis when passing through the rotating block 33, and it enters the rectangular prism 34. It is fully reflected twice at the reflecting surface 41 and the reflecting surface 42 of the rectangular prism 34, and it returns in the original direction. The returned signal light 45 is again shifted in its optical axis when passing through the rotating block 33, and the returned signal light 45 only partially passes through the output lens 40b to enter the output optical fiber 36c. The signal light 45 to come out of the other end of the output optical fiber 36c is attenuated. Similarly, when the rotating block 33 is tilted from the initial set angle, the signal lights 45 having come out of the input optical fiber 35a, 35b, and 35d are shifted in the optical axes at the rotating block 33 in the going and returning optical paths that the lights are reflected at the rectangular prism 34 and returned. The individual returning signal lights 45 only partially pass through the individual output lenses 40b to enter the individual output optical fibers 36a, 36b and 36d, and the signal lights 45 to come out of the other ends of the output optical fibers 36a, 36b and 36d are attenuated. Therefore, as the variable optical attenuator 71 of the Embodiment 5 shown in FIG. 19, when the rotating block 33 having the front face and the back face in parallel with each other is used, the signal lights 45 to come out of the other ends of the individual output optical fibers 36a, 36b, 36c and 36d can be adjusted collectively so as to have the same attenuation.

FIG. 20 is a schematic horizontal cross section illustrating a modification of the Embodiment 5. In a variable optical attenuator 72 of the modification, the back face of a rotating block 33 is formed in a curved or bent shape. According to the variable optical attenuator 72 like this, since the optical path length passing through the rotating block 33 is varied at every signal light 45 having come out of individual input optical fibers 35a, 35b, 35c and 35d, the shift amount of the optical axis can be varied at every signal light 45. Therefore, according to the modification, as shown in FIG. 21, the attenuation of the signal light 45 can be varied at each of the output optical fibers 36a, 36b, 36c and 36d (channels). The shape of the back face of the rotating block 33 is designed to provide a desired value to the attenuation at each of the output optical fibers 36a, 36b, 36c and 36d.

In addition, in the modification in FIG. 20, the back face of the rotating block 33 is curved or bent, but the front face of the rotating block 33, or the front face and the back face of the rotating block 33 may be curved or bent.

### Embodiment 6

FIG. 22 is a perspective view illustrating a variable optical attenuator 81 of Embodiment 6 according to the invention, and FIGS. 23 and 24 are both vertical cross sections thereof. In the variable optical attenuator 81, optical fibers are arranged in two stages above and below in an optical fiber array 32. In the upper stage, a plurality of output optical fibers 36a, 36b and so on is arranged in a line at a constant pitch, and in the lower stage, a plurality of input optical fibers 35a, 35b and so on is arranged in a line at a constant pitch. Moreover, the output optical fibers 36a, 36b and so on in the upper stage and the input optical fibers 35a, 35b and so on in the lower stage are arranged at an equal pitch, and the output optical fibers arranged above and below make a pair. The end faces of the individual optical fibers 36a, 36b and so on and 35a, 35b and so on are exposed from the optical fiber array 32.

A lens array 38 is fixed to the end face of the optical fiber array 32. In the lens array 38, lenses are also arranged in two stages above and below. The optical axis of a plurality of output lenses 40b arranged in the upper stage in a line is matched with the optical axis of the output optical fibers 36a, 36b and so on in the upper stage, and the optical axis of a plurality of input lenses 40a arranged in the lower stage in a line is matched with the optical axis of the input optical fibers 35a, 35b and so on in the lower stage.

A rectangular prism 34 has a column shape in an isosceles right triangle in cross section, and it is disposed in front of the optical fiber array 32 so that the direction vertical to the rectangular cross section (the lengthwise direction) faces in the horizontal direction (the Y-axis direction). A reflecting surface 41 of the rectangular prism 34 intersects across the extension line of the optical axis of the input optical fibers 35a, 35b and so on in the lower stage, and a reflecting surface 42 intersects across the extension line of the optical axis of the output optical fibers 36a, 36b and so on in the upper stage. An incoming and outgoing plane 43 faces in the direction of the lens array 38.

A rotating block array 82 formed of a plurality of transparent rotating blocks 33 is disposed between the lens array 38 and the rectangular prism 34. The individual rotating blocks 33 have a width equal to the arranged pitch of the input optical fibers 35a, 35b and so on or the output optical fibers 36a, 36b and so on, they can be separately rotated in the vertical plane (X-Z plane) manually or by an actuator (described later).

Then, in the variable optical attenuator 81, the individual rotating blocks 33 are rotated separately to adjust the attenuation of the signal light 45 between the input optical fibers and the output optical fibers making pairs above and below individually. Hereinafter, the case of the signal light 45 transmitted between the input optical fiber 35a and the output optical fiber 36a will be described with reference to FIGS. 23 and 24, and this is the same in the case transmission between other optical fibers paired above and below.

When the rotating block 33 is in the initial set angle, as shown in FIG. 23, the signal light 45 having come out of the end face of the core of the input optical fiber 35a is gathered at the input lens 40a in the lower stage to be parallel light. Then, it passes through straight the rotating block 33 to enter the rectangular prism 34, fully reflects twice at the reflecting surface 41 and the reflecting surface 42, returns in the original direction, and again passes through straight the rotating block 33. It is gathered at the output lens 40b in the upper stage to enter the output optical fiber 36b. In this case, almost all the luminous flux of the signal light 45 enters the output optical fiber 36b, and the attenuation of the signal light 45 is 0 dB.

On the other hand, when the rotating block 33 is tilted from the initial set angle as shown in FIG. 24, the signal light 45 having come out of the input optical fiber 35a passes through the rotating block 33 to shift the optical axis thereof. The signal light 45 having passed through the rotating block 33 enters the rectangular prism 34, fully reflects twice at the reflecting surfaces 41 and 42, returns in the original direction, and again passes through the rotating block 33. The returning signal light 45 passes through the rotating block 33 to also shift the optical axis thereof. Consequently, the signal light 45 is only partially gathered at the end face of the core of the output optical fiber 36b at the output lens 40b, and the light quantity entering the output optical fiber 36b is reduced to thus attenuate the signal light 45.

FIG. 25 shows a plan view illustrating the variable optical attenuator 81 having a plurality of actuators 83 which drive a rotating block array 82, and FIG. 26 shows a schematic cross section thereof. As shown in FIG. 27(a), the actuator 83 has a ribbon shape. Its base end part is fixed to the top face of a base substrate 46, and a rotating block 33 is fixed to the tip end part of the top face. The actuator 83 holding the rotating block 33 is arranged and disposed on the base substrate 46 to configure the rotating block array 82 on the tip end part of the actuator 83. For the actuator 83, a piezoelectric bimorph may be used which generates warpage by the piezoelectric effect when voltage is applied. Alternatively, it may be done that a belt shaped ribbon is formed by MEMS (micromachining technology) and the actuator 83 is bent against the elasticity of the ribbon by electrostatic repulsion or electrostatic attraction generated between electrodes (not shown) disposed between the tip end part of the ribbon and the top face of the base substrate 46.

Thus, the actuator 83 is electrically controlled to control the degree of the actuator 83 to bend as shown in FIG. 27(b) and 27(c), and the angle of each of the rotating blocks 33 is changed, thereby allowing adjustment of the attenuation of the variable optical attenuator 81. Furthermore, the actuator 83 shown in the drawing is used to reduce the variable optical attenuator 81 in size.

Moreover, the structure of arranging the input optical fibers 35a, 35b and so on the output optical fibers 36a, 36b and so on in two stages does not increase the width of the optical fiber array 32 as compared with the case where the individual optical fibers 35a, 35b to 36a are arranged in a line as the Embodiment 5. Therefore, the optical fiber array 32 can be reduced in size. Furthermore, the rectangular prism 34 is greatly increased in size as the number of optical fibers is increased in the case of the Embodiment 5. However, in the Embodiment 6, the rectangular prism 34 becomes longer but the size is not increased so much. Thus, the variable optical attenuator 81 can be more reduced in size than the case of the Embodiment 5.

With the use of 84 the actuator 83 like this, the rotating block 33 is accompanied by parallel motion, but when a block having the front face and the back face in parallel with each other is used, for example, when a rectangular transparent block is used as the rotating block 33, the attenuation is not affected by parallel motion of the rotating block 33 as described above.

### Embodiment 7

The variable optical attenuator of each of the embodiments described above can be added with a monitor output function. Hereinafter, an example will be taken and described that a monitor output function is added to the variable optical attenuator 31 of the Embodiment 1.

FIG. 28 is the variable optical attenuator 31 of the Embodiment 1 added with a monitor output function. The optical fiber array 32 holds input and output optical fibers 35 and 36 formed of a single mode fiber (the core diameter of about 10 μm) as well as a monitor optical fiber 92 formed of a multimode fiber (the core diameter of about 50 μm) or single mode fiber. The monitor optical fiber 92 is disposed at the position close to the output optical fiber 36 in parallel therewith. Furthermore, as shown in FIG. 29, an input lens 40a and a hybrid lens 94 are disposed on the front face of the lens array 38. The input lens 40a is positioned in front of the input optical fiber 35. The hybrid lens 94 is that an output lens 40b is combined with a monitor lens 93 in one piece. The output lens 40b is positioned in front of the output optical fiber 36, and the monitor lens 93 is positioned in front of the monitor optical fiber 92. The monitor lens 93 and the monitor optical fiber 92 are adjusted in the cores so that the optical axes are matched with each other. The other configurations are the same as those of the Embodiment 1, omitting the description.

The hybrid lens 94 is that the output lens 40b is combined with the monitor lens 93 in one piece in the shapes as shown in FIG. 30(c), having a front shape and a bottom shape as shown in FIGS. 30(a) and 30(b). First, the shape of the output lens 40b will be described. A circle 95 of the inner edge of the output lens 40b shown in FIG. 30(c) depicts a circle having a radius equal to the radius of the beam cross section of the incident signal light 45 (this is the same as the outer shape of the output lens 40b of the Embodiment 1). Furthermore, the outer edge of a circle 96 depicts properly greater than the circle 95, which is the outside diameter of the output lens 40b. The center of the circle 96 is matched with the center of the circle 95, and the optical axis of the output lens 40b is also matched with the centers. The output lens 40b has a shape that an outer area of the circle 95 is removed from a spherical or aspherical lens having the circle 96 as the outline at an angle of 180 degrees. A circle 97 of the edge of the monitor lens 93 shown in FIG. 30(c) is greater enough than the radius of the beam cross section (strictly, it is greater than a monitor condensing area, described later). The monitor lens 93 has a shape that an area overlapping with the output lens 40b is removed from a spherical or the aspherical lens having the circle 97 as the outline. Then, the hybrid lens 94 is configured so that a part of the output lens 40b is fit into the portion where the monitor lens 93 is partially removed. In addition, as shown in FIG. 30(b), the output optical fiber 36 is disposed so as to match with the optical axis of the output lens 40b, and the monitor optical fiber 92 is disposed so as to match with the optical axis of the monitor lens 93.

FIG. 31 shows an exemplary design of the hybrid lens 94 in more detail. First, the circle 95 is drawn that has the radius equal to the beam diameter of the signal light 45. A circle 98 is drawn that has the radius equal to the beam diameter of the signal light 45 so as to circumscribe the circle. Then, a circle 100 is drawn that circumscribes the circle 98 and passes through the intersection of the circle 95 and the normal (straight line 99) passing through the center of the circle 95. Furthermore, the large circle 96 concentric with the circle 95 is drawn, and one side of the straight line 99 is removed from the outside of the circle 95 to decide the outer shape of the output lens 40b. Furthermore, the large circle 97 concentric with the circle 98 is drawn, and an area overlapping with the output lens 40b is removed from the circle 97 to decide the shape of the monitor lens 93. Subsequently, a spherical or aspherical lens having the optical axis at the center of the circle 96 is partially cut to form the shape of the output lens 40b as described above. Moreover, a spherical or aspherical lens having the optical axis at the center of the circle 97 is partially cut to form the shape of the monitor lens 93 as described above. The area that the area of the circle 95 is removed from the area in the circle 100 is a monitor condensing area 101 (see FIG. 32), and the monitor condensing area 101 is an area having the diameter of about 175 μm, where the diameter of the signal light 45 is 100 μm.

The hybrid lens 94 is produced in an integral structure by application of aspherical lens fabrication technology. Although two lenses separately formed are bonded together, the lens is preferably formed integrally because optical loss occurs at the coupled portion.

FIGS. 32(a), 32(b), 32(c) and 32(d) are diagrams illustrative of the manner of split transition of the returning signal light 45 by the hybrid lens 94. As shown in FIG. 32(a), when the signal light 45 is incident into the circle 95, almost all the signal light 45 enters the output lens 40b, and it is gathered at the output lens 40b to enter the output optical fiber 36. On the other hand, when the signal light 45 is slightly shifted to the monitor lens 93 side, the irradiation area of the signal light 45 is off the circle 95. Thus, the signal light 45 in the circle 95 is gathered at the output lens 40b to enter the output optical fiber 36, whereas the signal light 45 off the circle 95 and entering the monitor condensing area 101 is all gathered at the monitor lens 93, and received at the monitor optical fiber 92. When the signal light 45 is moved more greatly and most of the irradiation area of the signal light 45 is off the circle 95, the slight signal light 45 in the circle 95 is gathered at the output lens 40b to enter the output optical fiber 36, whereas most of the signal light 45 off the circle 95 and entering the monitor condensing area 101 is gathered at the monitor lens 93, and received at the monitor optical fiber 92. Further, when the irradiation area of the signal light 45 is completely off the circle 95, almost all the signal light 45 is gathered at the monitor lens 93, and received at the monitor optical fiber 92.

In any of these states, it is revealed that the light off the output lens 40b (for example, the signal light 45 shown in FIG. 31) is all gathered at the monitor lens 93, and received at the monitor optical fiber 92 for use in monitoring. Therefore, no light occurs that is received at either the output lens 40b nor the monitor lens 93, and monitor sensitivity and monitor accuracy are improved. In addition, the signal light 45 that is not received at the output optical fiber 36 and the monitor optical fiber 92 is prevented from causing a temperature rise in the variable optical attenuator 31.

As apparent from the operation described above, for the output lens 40b, a spherical or aspherical lens depicted by the circle 95 is enough, and for the monitor lens 93, a lens that the circle 95 is removed from the spherical or aspherical lens depicted by the circle 100 is enough. However, in the embodiment, the output lens 40b is formed greater than the circle 95, and the monitor lens 93 is also formed greater than the area of the monitor condensing area 101. This is because weak light off the areas of the circle 95 and the monitor condensing area 101 is also gathered at the hybrid lens 94 to enter the output optical fiber 36 or the monitor optical fiber 92, thus reducing a temperature rise in the optical fiber array 32, etc., as much as possible.

In addition, the traditional variable optical attenuator has no monitor function. Therefore, as shown in FIG. 33, a splitter 103 which splits a signal light outputted from a variable optical attenuator 102 to 99:1 is connected to the subsequent stage of the variable optical attenuator 102 in which 99% of light is used as light output and 1% of light is used as monitor output. However, the configuration like this has problems that light output is lost and that monitor accuracy is low. The former problem is caused because the output from the variable optical attenuator 102 is split to 99:1 and the output from the splitter 103 is 99% of the output from the variable optical attenuator 102 to always lose 1% of output. Furthermore, the latter problem is caused because the light quantity of monitor output is only 1% of the output from the variable optical attenuator 102 and 1% of light has to be used to calculate the remaining 99% of light. Thus, monitor accuracy is low, and even though feedback control is done, it does not help to improve correction accuracy for the light outputs.

On the other hand, in the variable optical attenuator 31 of the Embodiment 7 according to the invention, since the output from the variable optical attenuator 31 is 100% outputted to the subsequent stage, there is a small light output loss. Particularly, since the hybrid lens 94 is used to generate less optical loss, control can be done more highly accurately. Moreover, since the difference between the input and the output of the variable optical attenuator 31 is the monitor output, the monitoring light quantity (absolute value) becomes great, and the attenuation of the signal light can be controlled highly accurately.

Besides, the variable optical attenuator 31 having the monitor output function as described above may be used to configure a control circuit incorporated variable attenuator 104 as shown in FIG. 34. The control circuit incorporated variable attenuator 104 has a rotating block 33, an actuator 105 which changes the angle of the rotating block 33, and an optical fiber array 32 having the monitor output function, which configure a variable optical attenuator 31 with the monitor function. The control circuit incorporated variable attenuator 104 further has a drive circuit 106 which drives the actuator 105, which controls the actuator 105 through the drive circuit 106 and controls the offset of a signal light 45 returning to the optical fiber array 32, a light receiving device 108 such as a photodiode (PD) which receives monitor light outputted from a monitor optical fiber 92 of the optical fiber array 32, and an amplifier circuit 109 which amplifies an output signal from the light receiving device 108 and inputs a feedback signal to the control circuit 107. Furthermore, the control circuit 107 communicates with an upper system 110 through control voltage or a control signal.

Next, the operation of controlling the attenuation by the control circuit incorporated variable attenuator 104 will be described. FIG. 36 is a flow chart illustrating the control operation. In adjustment or re-adjustment of the attenuation of a signal light 45, the control circuit 107 first outputs a control signal to the drive circuit 106 to drive the actuator 105, as shown in FIG. 35(a), the rotating block 33 is stopped at an angle that the signal light 45 returning to the optical fiber array 32 all enters the monitor lens 93 (alternatively, at the position where the light quantity of the monitor light is the maximum while monitoring the monitor light being received at the light receiving device 108) (Step S1). The received light quantity of the monitor optical fiber 92 is considered as the incident light quantity I1 of light input, and is stored in memory (Step S2). Subsequently, the attenuation that can holds the light output in a specification value O1 is computed from the value of the incident light quantity I1.

Then, the control circuit 107 outputs a control signal (control voltage) to the drive circuit 106 so as to be the computed attenuation (Step S3), and permits the actuator 105 to return the rotating block 33 at the original angle through the drive circuit 106 (Step S4). As shown in FIG. 35(b), when the rotating block 33 is stopped at the angle to be the computed attenuation, the light quantity that is off the output optical fiber 36 and enters the monitor optical fiber 92 is measured at the light receiving device 108 (Step S5), and the signal outputted from the light receiving device 108 is amplified at the amplifier circuit 109 and is fed back to the control circuit 107 as a monitor signal. The control circuit 107 calculates a light quantity O2 of the monitor light from the monitor signal, and computes the outgoing light quantity O3=I1-O2 outputted from the output optical fiber 36.

It is determined whether the computed value O3 of the outgoing light quantity is equal to the specification value O1 (Step S6). When it is unequal, the control circuit 107 compares the outgoing light quantity O3 computed from the light quantity O2 of the monitor light with the specification value O1, it feedback controls the angle of the rotating block 33 so that the outgoing light quantity is close to the specification value O1, and it corrects the outgoing light quantity.

In addition, since the received light quantity of the monitor optical fiber 92 becomes small in the area where the offset of the optical axis of the signal light 45 is small, it is difficult to find the position where the offset of the optical axis is zero, or to find the angle of the rotating block 33 where the received light quantity of the monitor optical fiber 92 becomes zero. In this case, it may be done that the angle that the monitor light quantity is zero is predicted based on the rate of change in the monitor light quantity before the received light quantity of the monitor optical fiber 92 is close to zero and on data stored beforehand.

Furthermore, the embodiments, the light quantity entering the output optical fiber is the maximum in the state that the rotating block is in parallel with the front face of the lens array, and the rotating block is tilted from that state to attenuate the signal light gradually. It may be done that the light quantity entering the output optical fiber is the maximum in the state that the rotating block is tilted, and the tilt of the rotating block is reduced to attenuate the signal light. Moreover, instead of the input lens and the output lens, an input diffraction grating and an output diffraction grating may be used.

### INDUSTRIAL APPLICABILITY

The variable optical attenuator according to the invention attenuates the light quantity and signal intensity of the light signal that propagates through a signal line to adjust it to a desired value in optical fiber communications. For example, according to the variable optical attenuator of the invention, the signal light that propagates through an optical fiber cable to be a weak signal can be amplified by an optical amplifier, and then the signal light can be adjusted to predetermined signal intensity at the variable optical attenuator for output.

1. A variable optical attenuator having at least a pair of optical transmission lines optically coupled, wherein all or a part of luminous flux coming out of one optical transmission line of the paired optical transmission lines is optically coupled to the other of the paired optical transmission lines, comprising:
a light transmissive member is arranged in an optical path that the optical transmission lines are optically coupled so that the member is allowed to change an angle thereof.

2. The variable optical attenuator according to claim 1, wherein an angle of the light transmissive member is changed to vary at least one angle of angles that the luminous flux coming out of one optical transmission line of the paired optical transmission lines enters the light transmissive member and that it comes out of the light transmissive member.

3. The variable optical attenuator according to claim 1, wherein the light transmissive member is capable of changing an angle thereof about a rotating shaft which is oriented in a direction vertical to a plane including each of optical axes of the paired optical transmission lines.

4. The variable optical attenuator according to claim 1, wherein a lens or a diffraction grating which controls incoming and outgoing luminous flux is disposed at a position facing an end face of the each of the optical transmission lines.

5. The variable optical attenuator according to claim 1, comprising an actuator which changes an angle of the light transmissive member.

6. The variable optical attenuator according to claim 1, comprising a monitor module which senses an attenuation of luminous flux that comes out of one optical transmission line of the paired optical transmission lines and enters the other optical transmission line.

7. The variable optical attenuator according to claim 1, wherein when luminous flux passes through the light transmissive member, a plane to which luminous flux enters the light transmissive member and a plane from which luminous flux comes out of the light transmissive member are configured of planes in parallel with each other.

8. The variable optical attenuator according to claim 1, comprising two or more pairs of optical transmission lines optically coupled,
wherein a single light transmissive member is disposed so as to intersect across individual optical paths which optical couple the paired optical transmission lines to each other.

9. The variable optical attenuator according to claim 1, comprising two or more pairs of optical transmission lines optically coupled,
wherein a light transmissive member is disposed separately in individual optical paths which optical couple the paired optical transmission lines to each other.

10. The variable optical attenuator according to claim 1, comprising two or more pairs of optical transmission lines optically coupled,
wherein when luminous flux passes through the light transmissive member, at least one plane of a plane to which luminous flux enters the light transmissive member and a plane from which luminous flux comes out of the light transmissive member is a curved face or a bent face.

11. The variable optical attenuator according to claim 1,
wherein the individual optical transmission lines are disposed in parallel with each other and in one piece,
the attenuator has an optical component which returns and optically couples luminous flux coming out of one optical transmission line of the paired optical transmission lines to the other optical transmission line of the paired optical transmission lines, and
the light transmissive member is disposed between each of the optical transmission lines and the returning optical component.

12. The variable optical attenuator according to claim 11,
wherein when luminous flux passes through the light transmissive member, a plane to which luminous flux enters the light transmissive member and a plane from which luminous flux comes out of the light transmissive member are both configured of planes, and
the plane from which luminous flux comes out is tilted with respect to the plane to which luminous flux enters.

13. The variable optical attenuator according to claim 11, wherein luminous flux coming out of one optical transmission line of the paired optical transmission lines passes through twice the light transmissive member in an optical path from one optical transmission line toward the returning optical component and in an optical path that is reflected at the returning optical component toward the other optical transmission line of the paired optical transmission lines.

14. The variable optical attenuator according to claim 12, wherein when luminous flux passes through the light transmissive member, a plane to which luminous flux enters the light transmissive member and a plane from which luminous flux comes out of the light transmissive member are configured of planes in parallel with each other.

15. The variable optical attenuator according to claim 11, comprising two or more pairs of optical transmission lines optically coupled,
wherein the individual optical transmission lines are arranged in a line at a constant pitch.

16. The variable optical attenuator according to claim 11, comprising two or more pairs of optical transmission lines optically coupled,
one optical transmission line of each of the paired optical transmission lines is arranged in a line, and the other optical transmission line of each of the paired optical transmission lines is arranged in a line, and
an arranged direction of one optical transmission line and an arranged direction of the other optical transmission line are in parallel with each other.
